(19) United States
(12) Patent Application Publication
(10) Pub. No.: US 2026/0303857 A1
(43) Pub. Date: Oct. 1, 2026

(54) VIDEO CODING

(71) Applicant: Tencent Technology (Shenzhen) Company Limited, Shenzhen (CN)

(72) Inventors: Renjie CHANG, Shenzhen (CN); Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/703,042

(22) Filed: Jun. 9, 2026

Related U.S. Application Data
(63) Continuation of application No. PCT/CN2025/099469, filed on Jun. 6, 2025.

(30) Foreign Application Priority Data
Jun. 7, 2024 (CN) 202410743791.0

(51) Int. Cl. H04N 19/523; H04N 19/105; H04N 19/117; H04N 19/139; H04N 19/167; H04N 19/172; H04N 19/176; H04N 19/186; H04N 19/52; H04N 19/80

(52) U.S. Cl. CPC H04N 19/523; H04N 19/105; H04N 19/117; H04N 19/139; H04N 19/167; H04N 19/172; H04N 19/176; H04N 19/186; H04N 19/52; H04N 19/80

(57) ABSTRACT

In a video decoding method, at least one reference block in a reference frame is determined based on at least one candidate motion vector of a current block. Based on a position of each of the at least one reference block, a respective template prediction region is determined. Based on pixel values in the template prediction region corresponding to each reference block, pixel values in a respective extension region are determined. Based on the pixel values in the extension region, sub-pixel interpolation values of the template prediction region corresponding to each reference block are determined. In the method, a target motion vector is searched through an inter-frame template match process based on the template of the current block and the sub-pixel interpolation values of the template prediction region corresponding to each reference block. The current block is reconstructed based on the target motion vector.

### RELATED APPLICATIONS

The present application is a continuation of International Application No. PCT/CN2025/099469, filed on Jun. 6, 2025, which claims priority to Chinese Patent Application No. 202410743791.0, filed on Jun. 7, 2024, and entitled “VIDEO ENCODING METHOD AND APPARATUS, VIDEO DECODING METHOD AND APPARATUS, COMPUTER-READABLE MEDIUM, AND ELECTRONIC DEVICE.” The entire disclosures of the prior applications are hereby incorporated by reference.

### FIELD OF THE TECHNOLOGY

This disclosure relates to the field of computer and communication technologies, including a video encoding method and apparatus, a video decoding method and apparatus, a non-transitory computer-readable storage medium, and an electronic device.

### BACKGROUND OF THE DISCLOSURE

Inter-frame template match (TM) corresponds to an inter prediction technology in the field of video encoding, and is intended to further refine a motion vector of a current block based on the TM technology, to obtain a more accurate prediction result. If a template prediction region in a reference frame is of a sub-pixel accuracy, interpolation filtering processing may be performed. When the interpolation filtering processing is performed, pixels in an interpolation extension region may be read based on the corresponding interpolation filters. This introduces large bandwidth overheads in hardware implementation, and excessively high hardware overheads limit actual application of the coding technology.

### SUMMARY

Embodiments of this disclosure include a video encoding method and apparatus, a video decoding method and apparatus, a non-transitory computer-readable storage medium, and an electronic device. A pixel value in a template prediction region may be configured to determine a pixel value in a first extension region for performing interpolation filtering processing in inter-frame template match (or also referred to as inter TM in this disclosure). In some embodiments, a decoder end does not need to decode pixel values in the first extension region from a bitstream (or store or load the pixel values in the first extension region), thereby reducing bandwidth overheads in hardware implementation, and improving video encoding and decoding efficiency.

Features and advantages of this disclosure are further described in the following descriptions of this disclosure.

According to a first aspect, an embodiment of this disclosure provides a video decoding method. In the method, at least one candidate motion vector of a current block is determined based on a bitstream. A template of the current block is constructed, the template including reconstructed pixel points adjacent to the current block. At least one reference block of the current block in a reference frame is determined based on the at least one candidate motion vector. In the method, based on a position of each of the at least one reference block, a respective template prediction region corresponding to each reference block in the reference frame is determined, a position of each template prediction region relative to a corresponding reference block being same as a position of the template relative to the current block. Based on pixel values in the template prediction region corresponding to each reference block, pixel values in a respective first extension region outside the corresponding template prediction region are determined. Based on the pixel values in the first extension region, sub-pixel interpolation values of the template prediction region corresponding to each reference block are determined through first interpolation filtering processing. In the method, a target motion vector is searched through an inter-frame template match process based on the template of the current block and the sub-pixel interpolation values of the template prediction region corresponding to each reference block. Pixel values of a matching block are determined based on the target motion vector. The current block is reconstructed based on the pixel values of the matching block.

According to a second aspect, an embodiment of this disclosure provides a video encoding method. In the method, video data is obtained. Based on the video data, at least one candidate motion vector of a current block is determined. A template of the current block is constructed, the template including pixel points adjacent to the current block. At least one reference block of the current block is determined in a reference frame based on the at least one candidate motion vector. In the method, based on a position of each of the at least one reference block, a respective template prediction region corresponding to each reference block in the reference frame is determined, a position of each template prediction region relative to a corresponding reference block being same as a position of the template relative to the current block. Based on pixel values in the template prediction region corresponding to each reference block, pixel values in a respective first extension region outside the corresponding template prediction region are determined. In the method, based on the pixel values in the first extension region, sub-pixel interpolation values of the template prediction region corresponding to each reference block are determined through first interpolation filtering processing. In the method, a target motion vector is searched through an inter-frame template match process based on the template of the current block and the sub-pixel interpolation values of the template prediction region corresponding to each reference block. Pixel values of a matching block are determined based on the target motion vector. The current block is encoded into a bitstream based on the pixel values of the matching block.

According to a third aspect, an embodiment of this disclosure provides a non-transitory computer-readable storage medium storing instructions which, when executed by a processor, cause the processor to perform a method of encoding a bitstream. In the method, video data is obtained. Based on the video data, at least one candidate motion vector of a current block is determined. A template of the current block is constructed, the template including pixel points adjacent to the current block. At least one reference block of the current block is determined in a reference frame based on the at least one candidate motion vector. In the method, based on a position of each of the at least one reference block, a respective template prediction region corresponding to each reference block in the reference frame is determined, a position of each template prediction region relative to a corresponding reference block being same as a position of the template relative to the current block. Based on pixel values in the template prediction region corresponding to each reference block, pixel values in a respective first extension region outside the corresponding template prediction region are determined. In the method, based on the pixel values in the first extension region, sub-pixel interpolation values of the template prediction region corresponding to each reference block are determined through first interpolation filtering processing. In the method, a target motion vector is searched through an inter-frame template match process based on the template of the current block and the sub-pixel interpolation values of the template prediction region corresponding to each reference block. Pixel values of a matching block are determined based on the target motion vector. The current block is encoded into the bitstream based on the pixel values of the matching block. In the method, the encoded bitstream is transmitted.

According to a fourth aspect, an embodiment of this disclosure provides a video decoding method, including: receiving a video bitstream; determining at least one candidate motion vector for inter TM of a current block based on the video bitstream; constructing a template of the current block, the template including reconstructed pixel points adjacent to the current block; determining at least one reference block of the current block in a reference frame based on the at least one candidate motion vector; determining, based on a position of each of the at least one reference block, a template prediction region corresponding to each reference block in the reference frame, a position of each template prediction region relative to a corresponding reference block being the same as a position of the template relative to the current block; determining, based on a pixel value in the template prediction region corresponding to each reference block, a pixel value in a first extension region for performing interpolation filtering processing on the corresponding template prediction region; and determining, based on the pixel value in the first extension region, sub-pixel interpolation of the corresponding template prediction region through the interpolation filtering processing, to serve as a predicted value of a template corresponding to the corresponding template prediction region.

According to a fifth aspect, an embodiment of this disclosure provides a video encoding method, including: determining, based on the video data, at least one candidate motion vector for inter TM of the current block; constructing a template of the current block, the template including pixel points adjacent to the current block; determining at least one reference block of the current block in a reference frame based on the at least one candidate motion vector; determining, based on a position of each of the at least one reference block, a template prediction region corresponding to each reference block in the reference frame, a position of each template prediction region relative to a corresponding reference block being the same as a position of the template relative to the current block; determining, based on a pixel value in the template prediction region corresponding to each reference block, a pixel value in a first extension region for performing interpolation filtering processing on the corresponding template prediction region; and determining, based on the pixel value in the first extension region, sub-pixel interpolation of the corresponding template prediction region through the interpolation filtering processing, to serve as a predicted value of a template corresponding to the corresponding template prediction region.

According to a sixth aspect, an embodiment of this disclosure provides a video decoding apparatus, including: a decoding unit, configured to receive a video bitstream, determine at least one candidate motion vector of a current block for inter TM based on the video bitstream, and construct a template of the current block, the template including reconstructed pixel points adjacent to the current block; a reference block determining unit, configured to determine at least one reference block of the current block in a reference frame based on the at least one candidate motion vector; a pixel value determining unit, configured to determine, based on a position of each of the at least one reference block, a template prediction region corresponding to each reference block in the reference frame, a position of each template prediction region relative to a corresponding reference block being the same as a position of the template relative to the current block; and determine, based on a pixel value in the template prediction region corresponding to each reference block, a pixel value in a first extension region for performing interpolation filtering processing on the corresponding template prediction region; and a processing unit, configured to determine, based on the pixel value in the first extension region, sub-pixel interpolation of the corresponding template prediction region through the interpolation filtering processing, to serve as a predicted value of a template corresponding to the corresponding template prediction region.

According to a seventh aspect, an embodiment of this disclosure provides a video encoding apparatus, including: a vector determining unit, configured to obtain video data, the video data including a current block; determine, based on the video data, at least one candidate motion vector for inter TM of the current block; and construct a template of the current block, the template including reconstructed pixel points adjacent to the current block; a reference block determining unit, configured to determine at least one reference block of the current block in a reference frame based on the at least one candidate motion vector; a pixel value determining unit, configured to determine, based on a position of each of the at least one reference block, a template prediction region corresponding to each reference block in the reference frame, a position of each template prediction region relative to a corresponding reference block being the same as a position of the template relative to the current block; and determine, based on a pixel value in the template prediction region corresponding to each reference block, a pixel value in a first extension region for performing interpolation filtering processing on the corresponding template prediction region; and a processing unit, configured to determine, based on the pixel value in the first extension region, sub-pixel interpolation of the corresponding template prediction region through the interpolation filtering processing, to serve as a predicted value of a template corresponding to the corresponding template prediction region.

According to an eighth aspect, an embodiment of this disclosure provides a non-transitory computer-readable storage medium, having a computer program stored therein, the computer program, when executed by processing circuitry (e.g., a processor), implementing the video decoding method or the video encoding method according to one or more embodiments in this disclosure.

According to a ninth aspect, an embodiment of this disclosure provides an electronic device, including: processing circuitry (e.g., one or more processors); and a storage apparatus, configured to store one or more computer programs, the one or more computer programs, when executed by the one or more processors, causing the electronic device to implement the video decoding method or the video encoding method according to one or more embodiments in this disclosure.

According to a tenth aspect, an embodiment of this disclosure provides a computer program product, including a computer program, the computer program being stored in a non-transitory computer-readable storage medium. Processing circuitry (e.g., a processor) of an electronic device reads the computer program from the non-transitory computer-readable storage medium and executes the computer program, so that the electronic device performs the video decoding method or the video encoding method provided in one or more embodiments in this disclosure.

### BRIEF DESCRIPTION OF THE DRAWINGS

FIG. 1 is a schematic diagram of a system architecture to which technical solutions of embodiments of this disclosure are applicable.

FIG. 2 is a schematic diagram of an arrangement mode of a video encoding apparatus and a video decoding apparatus in a streaming transmission system.

FIG. 3 is a basic flowchart of a video coder.

FIG. 4 is a schematic diagram of an angular prediction direction in an intra prediction mode.

FIG. 5 is a schematic diagram of intra prediction.

FIG. 6 is a schematic diagram of inter prediction.

FIG. 7 is a schematic diagram of inter prediction.

FIG. 8 is a schematic diagram of a diamond search.

FIG. 9 is a schematic diagram of pixel position distribution with a sub-pixel accuracy.

FIG. 10 is a schematic diagram of an interpolation range of an interpolation filter.

FIG. 11 is a schematic diagram of an inter-frame template match (or also referred to as inter TM in this disclosure) process.

FIG. 12 is a diagram of shapes of a coarse search and a fine search.

FIG. 13 is a schematic diagram of a search region and an interpolation extension region.

FIG. 14 is a flowchart of a video decoding method according to an embodiment of this disclosure.

FIG. 15 is a schematic diagram of a first extension region according to an embodiment of this disclosure.

FIG. 16 is a schematic diagram of setting a pixel value in a first extension region according to an embodiment of this disclosure.

FIG. 17 is a schematic diagram of setting a pixel value in a first extension region according to an embodiment of this disclosure.

FIG. 18 is a schematic diagram of setting a pixel value in a first extension region according to an embodiment of this disclosure.

FIG. 19 is a schematic diagram of a search region according to an embodiment of this disclosure.

FIG. 20 is a schematic diagram of a second extension region according to an embodiment of this disclosure.

FIG. 21 is a flowchart of a video encoding method according to an embodiment of this disclosure.

FIG. 22 is a block diagram of a video decoding apparatus according to an embodiment of this disclosure.

FIG. 23 is a block diagram of a video encoding apparatus according to an embodiment of this disclosure.

FIG. 24 is a schematic structural diagram of a computer system configured to implement an electronic device according to an embodiment of this disclosure.

### DETAILED DESCRIPTION

Embodiments are described as non-limiting examples with reference to the accompanying drawings. However, one or more embodiments may be implemented in various forms, and are not to be understood as being limited to examples described herein.

Descriptions of terms in this disclosure are provided as examples only and are not intended to limit the scope of the disclosure.

In addition, features, structures, or characteristics described in this disclosure may be combined in one or more embodiments in any proper manner. In the following descriptions, example details are provided for understanding one or more embodiments of this disclosure. However, a person skilled in the art is to be aware that, during implementation of the technical solutions in this disclosure, not all detailed features in one or more embodiments need to be used. One or more features may be omitted, or another method, unit, apparatus, operation, or the like may be used.

In one or more embodiments of this disclosure, the term “module” or “unit” refers to a computer program or a part of the computer program that has a preset function, and operates together with another relevant part to achieve a preset objective, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

The block diagrams shown in the accompanying drawings are merely functional entities and do not necessarily correspond to physically independent entities. In other words, the functional entities may be implemented in a form of software, or may be implemented in one or more hardware modules or integrated circuits, or may be implemented in different networks and/or processor apparatuses and/or microcontroller apparatuses.

The flowcharts shown in the accompanying drawings are merely non-limiting examples, and do not necessarily include all content and operations/blocks, nor do they have to be executed in the described order. For example, some operations/blocks may further be broken down, but some operations/blocks may be merged or partially merged. Therefore, an actual execution order may change according to an actual situation.

“A plurality of” mentioned herein means two or more. “And/or” describes an association relationship for describing associated objects and represents that three relationships may exist. For example, A and/or B may represent the following three cases: only A exists, both A and B exist, and only B exists. The character “/” generally indicates an “or” relationship between the associated objects.

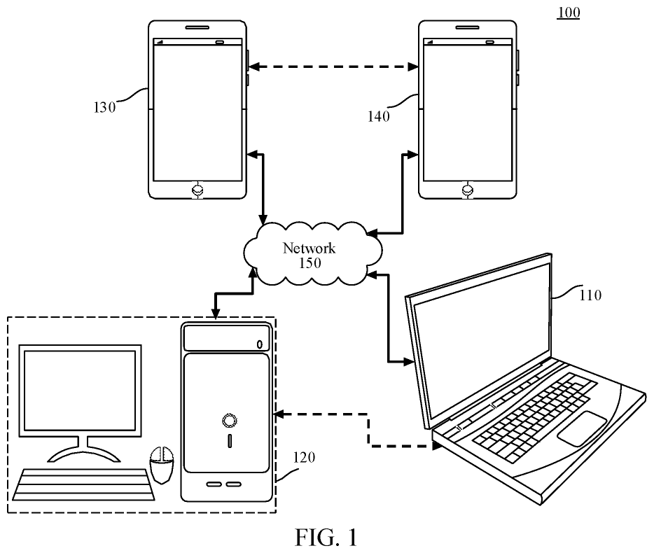

FIG. 1 is a schematic diagram of a system architecture to which technical solutions of embodiments of this disclosure are applicable.

As shown in FIG. 1, a system architecture 100 includes a plurality of terminal apparatuses. The terminal apparatuses may communicate with each other through, for example, a network 150. For example, the system architecture 100 may include a first terminal apparatus 110 and a second terminal apparatus 120 connected through the network 150. In FIG. 1, the first terminal apparatus 110 and the second terminal apparatus 120 perform unidirectional data transmission.

For example, the first terminal apparatus 110 may encode video data (for example, a video picture stream collected by the first terminal apparatus 110) and transmit the encoded video data to the second terminal apparatus 120 through the network 150. The encoded video data is transmitted in a form of one or more encoded video bitstreams. The second terminal apparatus 120 may receive the encoded video data through the network 150, decode the encoded video data to recover the video data, and display a video picture based on the recovered video data.

In an embodiment of this disclosure, the system architecture 100 may include a third terminal apparatus 130 and a fourth terminal apparatus 140 that perform bidirectional transmission of the encoded video data. The bidirectional transmission may be performed, for example, during a video conference. During the bidirectional data transmission, one of the third terminal apparatus 130 and the fourth terminal apparatus 140 may encode video data (for example, a video picture stream collected by a terminal apparatus) and transmit the encoded video data to the other of the third terminal apparatus 130 and the fourth terminal apparatus 140 through the network 150. One of the third terminal apparatus 130 and the fourth terminal apparatus 140 may further receive the encoded video data transmitted by the other of the third terminal apparatus 130 and the fourth terminal apparatus 140, and may decode the encoded video data to recover the video data and may display a video picture on an accessible display apparatus based on the recovered video data.

In FIG. 1, the first terminal apparatus 110, the second terminal apparatus 120, the third terminal apparatus 130, and the fourth terminal apparatus 140 may be servers or terminals, but the principles disclosed in this disclosure may not be limited thereto.

The server may be an independent physical server, or may be a server cluster or a distributed system formed by a plurality of physical servers, or may further be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be, for example, a smartphone, a tablet computer, a notebook computer, a desktop computer, a smart speaker, a smart voice interaction device, a smartwatch, a smart household appliance, an on-board terminal, an aircraft, or similar devices.

The network 150 shown in FIG. 1 represents any number of networks through which the encoded video data is transmitted among the first terminal apparatus 110, the second terminal apparatus 120, the third terminal apparatus 130, and the fourth terminal apparatus 140, including, for example, a wired and/or wireless communication network. The communication network 150 may exchange data in a circuit-switched and/or packet-switched channel. The network may include a telecommunications network, a local area network (LAN), a wide area network, and/or the Internet. For the purpose of this disclosure, unless explained below, an architecture and a topology of the network 150 may be inessential to operations disclosed in this disclosure.

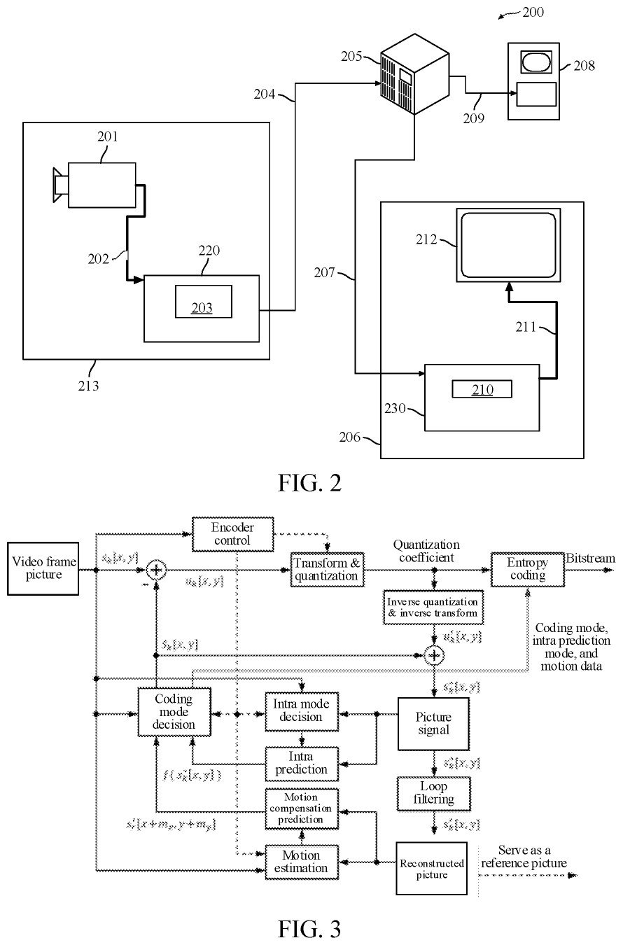

In an embodiment of this disclosure, FIG. 2 shows an arrangement mode of a video encoding apparatus and a video decoding apparatus in a streaming transmission environment. The subject disclosed in this disclosure may be comparably applicable to another examples supporting a video, including, for example, a video conference, a digital television (TV), and storage of compressed videos on a digital medium including a compact disc (CD), a digital video disk (DVD), and a memory stick.

A streaming transmission system may include a collection subsystem 213. The collection subsystem 213 may include a video source 201 such as a digital camera. The video source creates an uncompressed video picture stream 202. In an embodiment, the video picture stream 202 includes a sample captured by the digital camera. Compared with encoded video data 204 (or an encoded video bitstream 204), the video picture stream 202 is depicted by using a thick line to emphasize a video picture stream with a high data volume. The video picture stream 202 may be processed by an electronic apparatus 220. The electronic apparatus 220 includes a video encoding apparatus 203 coupled to the video source 201. The video encoding apparatus 203 may include hardware, software, or a combination of software and hardware to implement or execute aspects of the disclosed subject described in greater detail below. Compared with the video picture stream 202, the encoded video data 204 (or the encoded video bitstream 204) is depicted by a thin line to emphasize the encoded video data 204 (or the encoded video bitstream 204) with a small data volume, which may be stored in a streaming transmission server 205 for future use. One or more streaming transmission client subsystems, for example, a client subsystem 206 and a client subsystem 208 in FIG. 2, may access the streaming transmission server 205 to retrieve a copy 207 and a copy 209 of the encoded video data 204. The client subsystem 206 may include, for example, a video decoding apparatus 210 in an electronic apparatus 230. The video decoding apparatus 210 decodes an incoming copy 207 of the encoded video data, and generates an output video picture stream 211 that may be presented on a display 212 (for example, a display screen) or another display apparatus. In some streaming transmission systems, the encoded video data 204, the video data 207, and the video data 209 (for example, the video bitstream) may be encoded based on some video encoding/compression standards.

The electronic apparatus 220 and the electronic apparatus 230 may include other components not shown in the figure. For example, the electronic apparatus 220 may include a video decoding apparatus, and the electronic apparatus 230 may further include a video encoding apparatus.

In an embodiment of this disclosure, international video coding standards such as High Efficiency Video Coding (HEVC) and Versatile Video Coding (VVC) and Chinese national video coding standards such as Audio Video Coding Standard (AVS) are used as examples. After a video picture frame is inputted, the video picture frame is partitioned into several non-overlapping processing units based on a block size, and a similar compression operation is performed on each processing unit. The processing unit is referred to as a coding tree unit (CTU) or a largest coding unit (LCU). The CTU may further be partitioned more finely to obtain one or more basic coding units (CU). The CU is a most basic element in a coding process.

In another embodiment, the processing unit may also be referred to as a coding slice (namely, a tile), which is a rectangular region of a multimedia data frame that may be independently decoded and encoded. In the Alliance for Open Media Video 1 (AV1) standard, the coding slice may further be partitioned more finely to obtain one or more largest coding blocks (Superblock, SB for short). The SB is a starting point of block partition, and may further be partitioned into a plurality of sub-blocks, and then the largest coding block is further partitioned to obtain one or more blocks. Each block is a most basic element in a coding process. In one embodiment, one SB may include several blocks.

The foregoing partition mode for a video picture frame may be referred to as a block partition structure. Some concepts in the coding process are described below.

Predictive coding: The predictive coding includes modes such as intra prediction and inter prediction. After an original video signal is predicted through a selected reconstructed video signal, a residual video signal is obtained. An encoder end needs to select a predictive coding mode for a current CU (or a coding block) and notify a decoder end of the mode. The intra prediction means that a predicted signal comes from a region in the same picture that has been encoded and reconstructed. The inter frame prediction means that the predicted signal comes from another encoded picture (referred to as a reference picture) that is different from a current picture.

Transform & quantization: A residual video signal undergoes a transformation operation such as a Discrete Fourier transform (DFT) and a Discrete Cosine Transform (DCT), to convert a signal into a transform domain, which is referred to as a transform coefficient. A lossy quantization operation is further performed on the transform coefficient, which loses a specific amount of information, so that the quantized signal facilitates compressed expression. In some video coding standards, more than one transform modes may be selected. Therefore, the encoder end also needs to select one of the transform modes for the current CU (or the coding block) and inform the decoder end. Fineness of quantization is generally determined by a quantization parameter (QP). A larger QP indicates that coefficients within a larger value range are to be quantized to the same output, which usually brings larger distortion and a lower bit rate. On the contrary, a smaller QP indicates that coefficients within a smaller value range are to be quantized to the same output, which usually brings less distortion and a higher bit rate.

Entropy coding or statistical coding: Statistical compression coding is performed on the quantized signal in the transform domain based on a frequency of occurrence of each value, and finally a binarized (0 or 1) compressed bitstream is outputted. In addition, entropy coding also needs to be performed on another information generated through coding, such as a selected coding mode and motion vector data, to reduce a bit rate. Statistical coding is a lossless coding mode that may effectively reduce a bit rate required for expressing the same signal. A common statistical coding mode includes variable length coding (VLC) or context adaptive binary arithmetic coding (CABAC).

A CABAC process mainly includes 3 operations: binarization, context modeling, and binary arithmetic coding. After binarization processing is performed on an input syntax element, binary data may be encoded through a conventional coding mode and a bypass coding mode. In the bypass coding mode, a specific probability model does not need to be allocated to each binary digit, and an input binary digit bin value is directly encoded through a simple bypass coder, to accelerate entire coding and decoding. Generally, different syntax elements may not be independent of each other, and the same syntax element also has some memorability. Therefore, based on a conditional entropy theory, conditional coding is performed through another coded syntax element, and coding performance can be further improved compared with independent coding or memoryless coding. The encoded symbol information used as a condition is referred to as a context. In a conventional coding mode, binary digits of the syntax element sequentially enter a context modeling device. An encoder allocates an appropriate probability model to each input binary digit based on a value of a syntax element or a binary bit that has been encoded previously. This process is context modeling. A context model corresponding to the syntax element may be positioned through a context index increment (ctxIdxInc) and a context index start (ctxIdxStart). After the bin value and the allocated probability model are both inputted into a binary arithmetic coder for coding, the context model needs to be updated based on the bin value, which is an adaptation process during coding.

Loop filtering: Operations of inverse quantization, inverse transform, and predictive compensation are performed on a transformed and quantized signal to obtain a reconstructed picture. The reconstructed picture has some information different from that in an original picture as a result of quantization. In other words, the reconstructed picture has distortion. Therefore, a filtering operation may be performed on the reconstructed picture by using filters such as a deblocking filter (DB), a sample adaptive offset (SAO) filter, or an adaptive loop filter (ALF), which can effectively reduce a degree of distortion caused by quantization. Since the filtered reconstructed picture will be used as a reference for subsequently coding pictures so as to predict future picture signals, the above filtering operation is also referred to as loop filtering, namely, a filtering operation in a coding loop.

In an embodiment of this disclosure, FIG. 3 is a basic flowchart of a video coder. In this process, intra prediction is used as an example for description. A difference between an original picture signal sₖ[x, y] and a predicted picture signal ŝₖ[x, y] is calculated to obtain a residual signal uₖ[x, y], and the residual signal uₖ[x, y] is transformed and quantized to obtain a quantization coefficient. The quantization coefficient is subjected to entropy coding to obtain an encoded bitstream, and is further subjected to inverse quantization and inverse transform to obtain a reconstructed residual signal u′ₖ[x, y]. The predicted picture signal ŝₖ[x, y] is superimposed with the reconstructed residual signal u′ₖ[x, y] to generate a picture signal sₖ^{*}[x, y]. The picture signal sₖ^{*}[x, y] is inputted to an intra mode decision module and an intra prediction module for intra prediction processing, and is further subjected to loop filtering to output a reconstructed picture signal s′ₖ[x, y]. The reconstructed picture signal s′ₖ[x, y] may be used as a reference picture for a next frame for motion estimation and motion compensation prediction. Then a predicted picture signal ŝₖ[x, y] of the next frame is obtained based on a result s′ᵣ[x+m, y+m_{y}] of the motion compensation prediction and a result f(sₖ^{*}[x, y]) of the intra prediction. The above process is repeated until the coding is completed.

Based on the foregoing coding process, on the decoder end, for each CU (or a coding block), after a compressed bitstream (or also referred to as a code stream) is obtained, entropy decoding is performed to obtain various mode information and quantization coefficients. Then inverse quantization and inverse transform are performed on the quantization coefficients to obtain a residual signal. In addition, a predicted signal corresponding to the CU (or the coding block) may be obtained based on coding mode information that is known. Then the residual signal and the predicted signal may be added together to obtain a reconstructed signal. The reconstructed signal is then subjected to operations such as loop filtering to generate a final output signal. In the series of encoding processes, an encoding framework mainly relies on rate-distortion optimization (RDO) for decision-making, to select an optimal encoding parameter.

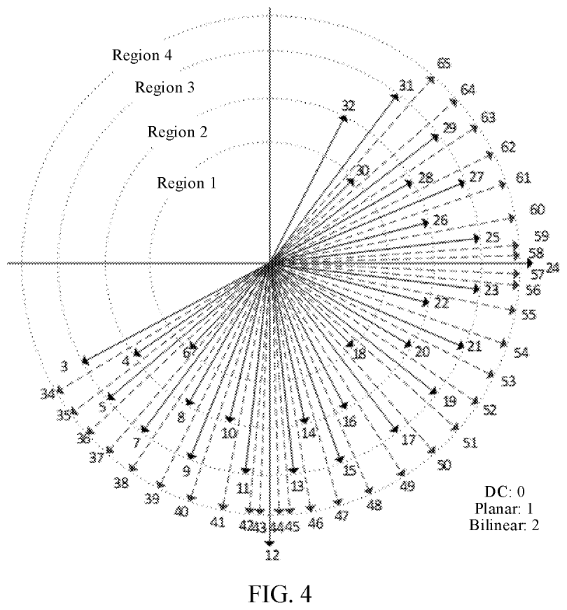

In the field of coding technologies, the intra prediction is a common predictive coding technology. The intra prediction derives a predicted value of a current coding block from an adjacent encoded region based on a correlation that exists between pixels of a video picture in a space domain. In the second stage of AVS3, an extended intra prediction mode (EIPM) is adopted. The previous generation AVS2 supports 33 intra prediction modes in total, including 30 angular prediction modes and 3 special prediction modes (a plane prediction mode, a DC prediction mode, and a bilinear prediction mode). Coding is performed through 2 most probable modes (MPM), and coding is performed through fixed-length coding of 5 bits in the remaining modes. To support finer angular prediction, the AVS3 extends to support 62 angular prediction modes. As shown in FIG. 4, numbers of newly added angular prediction modes are 34 to 65.

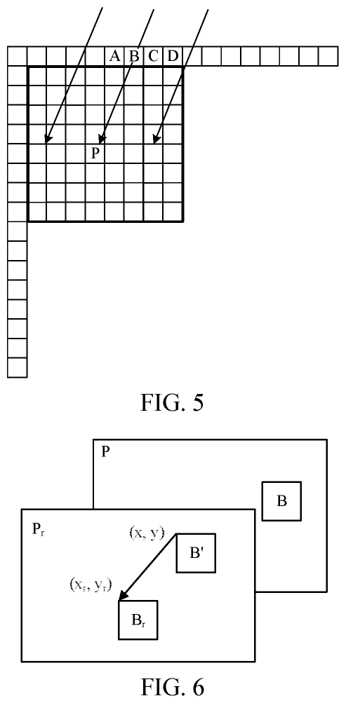

When the angular prediction mode is used, for a pixel point in a current prediction block, a reference pixel value at a corresponding position on a reference pixel row or column is used as a predicted value based on a direction corresponding to an angle of the prediction mode. As shown in FIG. 5, for a pixel point P in a prediction block, a position of a reference pixel is first determined from an encoded pixel row above based on a predicted angle in the figure, and then a reference pixel value is used as a predicted value of the pixel point P. Not all pixel positions point to reference pixel positions with an integer-pixel accuracy. For example, a reference pixel position of the pixel point P in FIG. 5 is a fractional-pixel position between pixels B and C. Therefore, a predicted pixel value of the position needs to be obtained through interpolation through surrounding pixels. To improve intra prediction efficiency, an on-chip memory is usually configured to store a reference pixel for intra prediction.

As shown in FIG. 6, the inter prediction is to predict, through correlation of a video in a time domain, a pixel of a current picture by using a pixel of an adjacent encoded picture, so as to effectively remove redundancy of the video in the time domain, thereby effectively reducing bits for coding residual data. P represents a current frame, Pr represents a reference frame, B represents a current coding block, and Br represents a reference block of B. Coordinates of B′ in the reference frame are the same as coordinates of B in the current frame. The coordinates of Br are (xr, yr), and the coordinates of B′ are (x, y). Displacement between the current coding block and the reference block thereof is referred to as a motion vector (MV), where MV=(xr−x, yr−y). In other words, the inter prediction refers to a process in which a search is performed in an adjacent encoded picture (namely, a reference frame) based on a to-be-encoded current block in a current frame, to obtain a reference block, so as to remove redundancy of a video signal in the time domain. As shown in FIG. 7, the to-be-encoded current block in the current frame is searched in a specified range (namely, in a search region defined by a search box) in the reference frame based on a block matching criterion, to obtain an optimal matching block. In one embodiment, common block matching criteria in video encoding include matching criteria such as a minimum mean square error (MSE) and a sum of absolute difference (SAD).

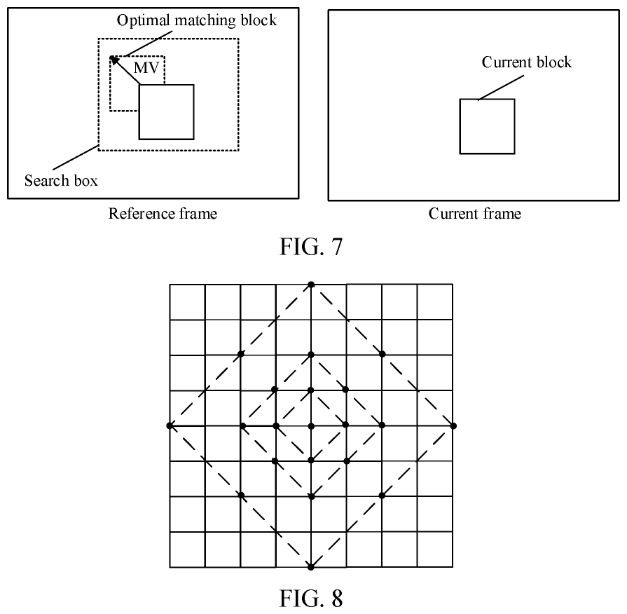

Generally, a plurality of different search shapes or search algorithms may be used in a motion estimation search process. A full search algorithm is a most direct search algorithm, namely, all possible pixel positions in the search box are traversed, and an MV corresponding to an obtained optimal matching block is a global optimal MV. However, the full search is relatively more complex, and a quick search algorithm such as a two-dimensional logarithm search algorithm, a three-step search algorithm, and a TZSearch algorithm is usually used. For example, as shown in FIG. 8, a candidate motion vector prediction (MVP) is used as a starting point of a search (namely, a point at the center shown in FIG. 8), the search is performed in a diamond search region. A search step size increases by an integer power of 2, and a point having a smallest rate-distortion cost is selected as an optimal search result for a current search stage.

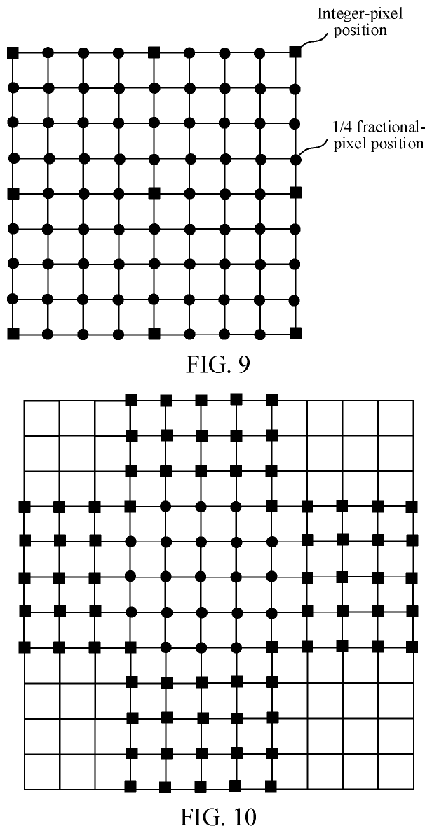

Because inter prediction needs to obtain a pixel predicted value in a reference frame by using the MV, and in an actual case, motion of an object between adjacent picture frames is not necessarily performed by using an integer pixel as a basic unit, an accuracy of motion estimation needs to be improved to a sub-pixel level. In other words, interpolation needs to be performed on a reference picture, to improve the accuracy of motion compensation, thereby improving encoding efficiency. FIG. 9 is a schematic diagram of pixel position distribution with a sub-pixel accuracy. A black square represents an integer-pixel position (resolution of all integer pixels of a frame is equal to video resolution), and a black circle represents a ¼ fractional-pixel position. A common inter prediction mode in AVS3 supports five types of motion vector accuracies, namely ¼, ½, 1, 2, and 4. When the MV accuracy is ¼ or ½, an 8-tap interpolation filter may be configured to perform interpolation to obtain a luminance prediction value, and a 4-tap interpolation filter may be configured to obtain a chrominance prediction value. When fractional pixels at boundaries of a current prediction block are interpolated, an 8-tap or 4-tap interpolation calculation usually needs to be performed by additionally reading pixels outside the current prediction block. In other words, a total quantity of pixels needed in an interpolation process is usually greater than a total quantity of pixels of the current prediction block. In an example, FIG. 10 shows a pixel range needed by an 8-tap interpolation filter to perform horizontal interpolation and vertical interpolation given a ¼ pixel accuracy (where a black square shown in FIG. 10 represents an integer-pixel position, a black circle represents a ¼ fractional-pixel position, and the black square represents an integer-pixel position outside a prediction block).

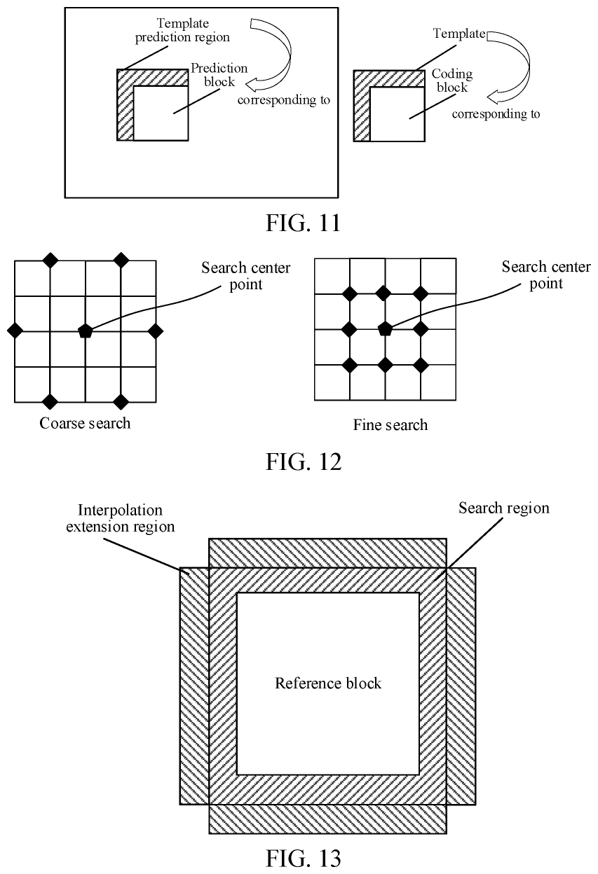

Inter-frame template match (or also referred to as inter TM in this disclosure) corresponds to an inter prediction technology in the field of video encoding, and is intended to further refine a motion vector of a current block based on the TM technology, to obtain a more accurate prediction result. In an example, M motion vector predictions (MVP) are first obtained from an advanced motion vector prediction (AMVP), a Skip, or a Direct mode in an inter prediction process, to serve as candidate MVPs of a current to-be-predicted block (namely, a coding block shown in FIG. 11). A template region (a width of the template region is N, and Nis a positive integer) is then constructed based on reconstructed pixels around the current to-be-predicted block, and then a TM search is performed on each available direction of the candidate MVPs, to determine an optimal matching block.

The inter TM usually uses a mode of a coarse search followed by a fine search. In a coarse search process, a corresponding candidate MVP is used as a search starting point in a reference frame corresponding to each candidate MVP, a search mode of a specific shape is configured for continuously updating the initial MVP, and a cost between a template prediction region (as shown in FIG. 11) in the reference frame corresponding to the updated MVP and a template region of a current to-be-predicted block (namely, the coding block shown in FIG. 11) is calculated during each search. If the template prediction region in the reference frame is a sub-pixel accuracy region, interpolation needs to be performed to generate the template prediction region, and then a cost calculation is performed. In each search process, a point with a minimum template cost is used as a center point for a next search. If the center point is optimal, the current search is suspended. Finally, after an optimal coarse search MV is obtained, a fine search is performed based on a specific shape, to obtain an optimal MV (or also referred to as a target MV). FIG. 12 is an example of shapes of a coarse search and a fine search. A main difference between the coarse search and the fine search lies in different search step sizes.

After an optimal MV (e.g., a target MV) is obtained through searching, inter TM generates a matching block (namely, an optimal reference block) corresponding to a current block by directly using the interpolation filtering method described in the foregoing embodiment. Therefore, to smoothly generate the matching block of the current block, in addition to a reference block (for example, in FIG. 11, the current block is a coding block, and the reference block is a prediction block) corresponding to the current block, the inter TM further needs to obtain a pixel outside a specific range of the reference block (namely, a pixel in a search region) and an additional pixel (namely, a pixel in an interpolation extension region) that may be needed in a final interpolation process. As shown in FIG. 13, in an embodiment, a search region is a set-size region surrounding a reference block, and an interpolation extension region is a set-size region outside the search region.

From a perspective of a decoder end, to generate a prediction block of a current block, in a common inter prediction technology, a reference block having a corresponding pixel size in the reference frame may be read based on an MV, while in an inter TM technology, a pixel in the search region and a pixel in the interpolation extension region may further be additionally read. In addition, when interpolation filtering processing is to be performed on a template prediction region, a pixel in an interpolation extension region corresponding to the template prediction region may further be read. It can be learned that the inter TM technology may introduce relatively large bandwidth overheads in hardware implementation, and high hardware overheads may limit actual application of the coding technology.

Based on the above, the technical solutions in one or more embodiments of this disclosure propose a video encoding and decoding technology applied to inter TM. A pixel value in an interpolation extension region (including an interpolation extension region in an inter TM process and an interpolation extension region in motion compensation) may be determined by using an existing pixel value in a reference frame, so that a decoder end may avoid decoding the pixel value in the interpolation extension region from a bitstream during decoding, to avoid additionally reading more pixels in an actual encoding and decoding process and reduce bandwidth overheads in hardware implementation, thereby helping improve video encoding and decoding efficiency.

Implementation details of the technical solutions in one or more embodiments of this disclosure are described in further detail below.

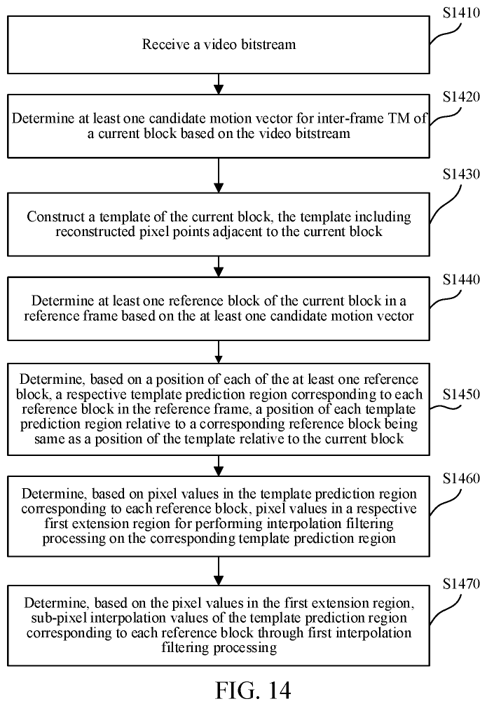

FIG. 14 is a flowchart of a video decoding method according to an embodiment of this disclosure. The video decoding method may be performed by an electronic device having a computing processing function, for example, may be performed by a terminal device or a server. Referring to FIG. 14, the video decoding method includes at least S1410 to S1470. A detailed description is as follows.

S1410: Receive a video bitstream.

S1420: Determine at least one candidate motion vector for inter TM of a current block based on the video bitstream.

In some embodiments, a video includes a video picture frame sequence, the video picture frame sequence includes a series of pictures, each picture may be further partitioned into slices, the slice may be further partitioned into a series of LCUs (or CTUs), and the LCU includes several CUs. The video picture frame is encoded by block during coding. In some new video coding standards, for example, in the H.264 standard, a macroblock (MB) is provided. The MB may be further partitioned into a plurality of prediction blocks that may be configured for predictive coding. In the HEVC standard, basic concepts such as a CU, a prediction unit (PU), and a transform unit (TU) are used, various block units are partitioned by function, and a new tree-based structure is configured for description. For example, a CU may be partitioned into smaller CUs according to a quadtree, and the smaller CUs may be further partitioned to form a quadtree structure. The current block, the reference block, and the matching block in this embodiment of this disclosure may be a CU, or a block smaller than the CU, for example, a smaller block obtained by partitioning the CU.

In some embodiments, one or more candidate motion vectors of the current block may be configured for inter TM. The candidate motion vector may be directly obtained by decoding the video bitstream, or one or more motion vectors obtained from an AMVP, a Skip, or a Direct mode in an inter prediction process may be used as the candidate motion vector of the current block.

S1430: Construct a template of the current block, the template including reconstructed pixel points adjacent to the current block. For example, a template of the current block in FIG. 11.

S1440: Determine at least one reference block of the current block in a reference frame based on the at least one candidate motion vector.

In some embodiments, a position corresponding to the current block may be located in the reference frame by using the candidate motion vector. The position is the reference block corresponding to the current block.

S1450: Determine, based on a position of each of the at least one reference block, a respective template prediction region corresponding to each reference block in the reference frame, a position of each template prediction region relative to a corresponding reference block being the same as a position of the template relative to the current block. In addition, a shape and a size of each template prediction region are consistent with those of the template.

S1460: Determine, based on a pixel value in the template prediction region corresponding to each reference block, a pixel value in a first extension region for performing first interpolation filtering processing on the corresponding template prediction region. In some examples, based on pixel values in the template prediction region corresponding to each reference block, pixel values in a respective first extension region outside the corresponding template prediction region are determined.

In some embodiments, the template prediction region may include a pixel region located above the reference block and a pixel region located to the left of the reference block. In an example, as shown in FIG. 11, the template prediction region is the pixel region located above the reference block (namely, the prediction block shown in FIG. 11) and the pixel region located to the left of the reference block, namely, a shadow region formed to the left of and above the prediction block shown in FIG. 11.

The first extension region includes at least one of the following: a pixel region in a first quantity of rows above the template prediction region; a pixel region in a second quantity of rows below the template prediction region; a pixel region in a third quantity of columns to a left side of the template prediction region; a pixel region in a fourth quantity of columns to a right side of the template prediction region; a pixel region adjacent to an upper left corner of the template prediction region; a pixel region adjacent to an upper right corner of the template prediction region; a pixel region adjacent to a lower left corner of the template prediction region; or a pixel region adjacent to a lower right corner of the template prediction region. In some embodiments, the first quantity, the second quantity, the third quantity, and the fourth quantity may be equal, or may not be equal, or may be partially equal, and for example, may be selected from 1, 2, 3, 4, 5, or 6.

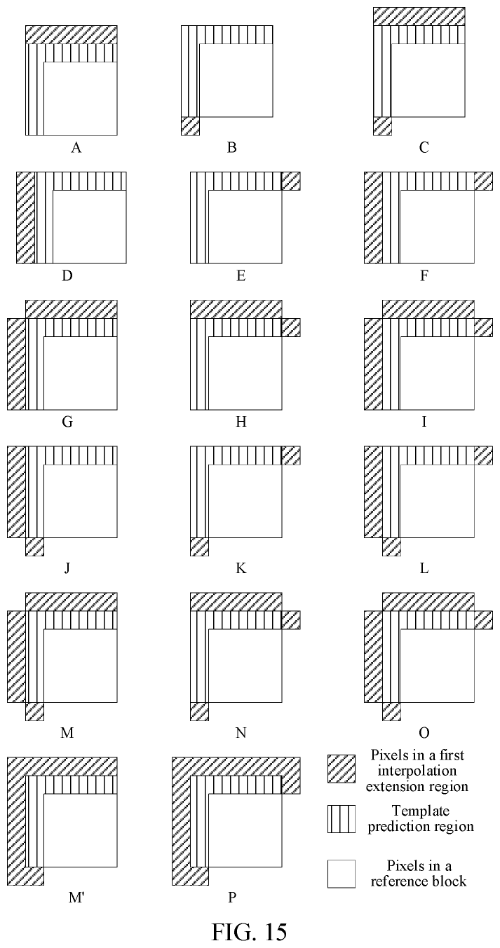

In some embodiments, as shown in FIG. 15, the first extension region may be set in a plurality of modes (the setting mode in FIG. 15 is merely an example). In other words, the first extension region may be located on at least one side of the template prediction region, including above, below, to the left, or to the right thereof. In some embodiments, the first extension region may further include pixel regions at one or more of an upper left corner, an upper right corner, a lower left corner, or a lower right corner in Mode A to Mode O shown in FIG. 15. As shown in FIG. 15, Mode M is used as an example. If pixel regions at the upper left corner and the lower left corner are included, the first extension region may be illustrated as Mode M′ in FIG. 15. Mode O shown in FIG. 15 is used as another example. If pixel regions at the upper left corner, the upper right corner, the lower left corner, and the lower right corner are included, the first extension region may be illustrated as Mode P in FIG. 15.

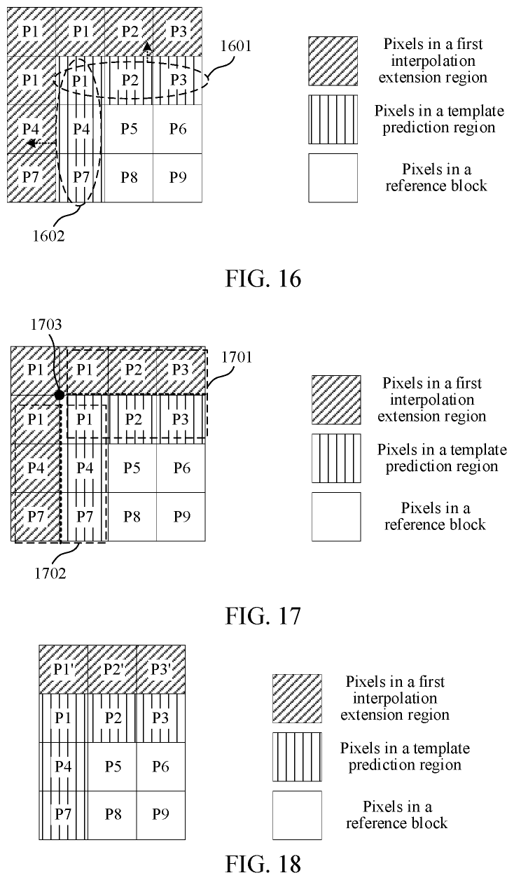

In some embodiments, when the pixel value in the first extension region is determined, a pixel value in the template prediction region may be copied, to serve as the pixel value in the first extension region. For example, several pixel values are copied and filled into set positions in the first extension region. In FIG. 16, a pixel value at a position 1601 in the template prediction region and a pixel value at a position 1602 in the template prediction region may be copied, to serve as pixel values at corresponding positions in the first extension region. In addition, a pixel value at the upper left corner of the first extension region may be obtained by copying a pixel value at a specified position (for example, a pixel value at the upper left corner of the template prediction region or a pixel value at an adjacent position in the first extension region).

In some embodiments, when the pixel value in the first extension region is determined, replication may be performed on the pixel value in the template prediction region based on an axis of symmetry, to obtain the pixel value in the first extension region. In FIG. 17, replication is performed in a square dashed box 1701, to obtain a pixel value at a corresponding position in the first extension region. Replication is performed in a square dashed box 1702, to obtain the pixel value at the corresponding position in the first extension region.

In some embodiments, when the pixel value in the first extension region is determined, replication may be performed on the pixel value in the template prediction region based on a symmetry point, to obtain the pixel value in the first extension region. As shown in FIG. 17, a pixel value at an upper left corner of the first extension region is obtained by performing replication based on a symmetry point 1703.

In some embodiments, when the pixel value in the first extension region is determined, a weighted calculation may be performed on the pixel value in the template prediction region, to obtain the pixel value in the first extension region. For example, in FIG. 18, in the first extension region, P1′=(2*P4+P1+P7+2)>>2; in the first extension region, P2′=(2*P5+P2+P8+2)>>2; and in the first extension region, P3′=(2*P6+P3+P9+2)>>2.

In some embodiments, when the pixel value in the first extension region is determined, intra prediction processing may be performed based on the pixel value in the template prediction region, to obtain the pixel value in the first extension region. For example, the pixel value at the corresponding position in the first extension region may be filled based on calculation formulas of an angle mode, a direct current (DC) mode, and a planar mode.

One or more embodiments in this disclosure may be used in combination, or may be used separately. In addition, the pixel value at the upper left corner of the first extension region may be obtained in another mode such as copying or mirroring a pixel value above or a pixel value to the left of the first extension region, or may be obtained in one of manners such as a weighted calculation and intra prediction. The pixel value at the upper right corner of the first extension region may be obtained in another manner such as copying or mirroring the pixel value above or a pixel value to the right of the first extension region, or may be obtained in one of the manners such as the weighted calculation and the intra prediction. The pixel value at the lower left corner of the first extension region may be obtained in another manner such as copying or mirroring a pixel value below or the pixel value to the left of the first extension region, or may be obtained in one of the modes such as the weighted calculation and the intra prediction. The pixel value at the lower right corner of the first extension region may be obtained in another manner such as copying or mirroring the pixel value below or the pixel value to the right of the first extension region, or may be obtained in one of the manners such as the weighted calculation and the intra prediction.

S1470: Determine, based on the pixel value in the first extension region, sub-pixel interpolation of the corresponding template prediction region through the interpolation filtering processing, to serve as a predicted value of a template corresponding to the corresponding template prediction region. In some examples, based on the pixel values in the first extension region, sub-pixel interpolation values of the template prediction region corresponding to each reference block are determined through first interpolation filtering processing. In some examples, a target motion vector (e.g., an optimal MV) is searched through an inter-frame template match process based on the template of the current block and the sub-pixel interpolation values of the template prediction region corresponding to each reference block. In some examples, pixel values of a matching block are determined based on the target motion vector, and the current block is reconstructed based on the pixel values of the matching block.

In some embodiments, after first interpolation filtering processing is performed on the template prediction region to obtain the predicted value of the template, inter TM may be performed based on the predicted value of the template, to obtain an optimal motion vector corresponding to the at least one candidate motion vector. In an example, a cost between the template prediction region and the template region of the current block may be calculated, and then a point with a minimum template cost is selected as a center point for a next search. If the center point is optimal, the current search is suspended. Finally, after an optimal coarse search motion vector is obtained, a fine search is performed based on a specific shape, to obtain the optimal motion vector.

In some embodiments, after the optimal motion vector is obtained, the matching block corresponding to the current block may be determined based on the optimal motion vector, and then the pixel values of the matching block may be determined based on the position of the matching block through second interpolation filtering processing. In some embodiments, when the interpolation filtering processing is performed to obtain the matching block, a relevant interpolation filtering method may be used. For example, the second interpolation filtering processing may be performed by reading pixels in the search region and pixels in a second extension region (namely, an interpolation extension region for performing the interpolation filtering processing during the motion compensation) for performing the second interpolation filtering processing to obtain the matching block. In some examples, the second interpolation filtering processing may be performed by using a bilinear interpolation method, a nearest neighbor interpolation method, a bicubic interpolation method, a 6-tap interpolation filter, a 12-tap interpolation filter, or the like.

In some embodiments, when the second interpolation filtering processing is performed to obtain the matching block, a pixel value in the second extension region for performing the second interpolation filtering processing during the motion compensation may be determined based on a pixel value in a target reference region in the reference frame. Then the interpolation filtering processing is performed to obtain the matching block based on the second extension region. In some examples, based on pixel values in a target reference region in the reference frame, pixel values in a second extension region outside the target reference region are determined. In some examples, based on the pixel values in the second extension region and the target reference region, the pixel values of the matching block are determined through the second interpolation filtering processing. According to the technical solution of this embodiment, the pixel value in the second extension region may not need to be decoded from a bitstream, so as to reduce bandwidth overheads in hardware implementation, thereby helping improve video encoding and decoding efficiency.

In some embodiments, the target reference region for determining the pixel value in the second extension region may include at least one of the following: a first pixel position included in a search region in the reference frame or a second pixel position in the corresponding one of the at least one reference block from which the target motion vector is determined. In other words, the target reference region includes at least one of the following: a sub-region in the search region or a sub-region of the reference block corresponding to the matching block. The reference block corresponding to the matching block is a reference block determined by using an initial candidate motion vector (which is the candidate motion vector generated in operation S1430) corresponding to the optimal motion vector. A local search is performed by using the candidate motion vector corresponding to each reference block as the initial candidate motion vector, so that the optimal motion vector corresponding to each candidate motion vector can be determined. Based on this, an optimal motion vector for determining the matching block, namely, the optimal motion vector corresponding to a plurality of candidate motion vectors, may be selected from the plurality of optimal motion vectors corresponding to the plurality of candidate motion vectors. In some embodiments, the first pixel position may be a position of one pixel or may be positions of a plurality of pixels. The second pixel position may be a position of one pixel or may be positions of a plurality of pixels. When the pixel value in the second extension region is determined based on the pixel value in the target reference region, reference may be made to the solution of determining the pixel value in the first extension region. In other words, the pixel value in the second extension region may be obtained through one or more of copying the pixel value in the target reference region, performing replication on the pixel value in the target reference region based on an axis of symmetry, performing replication based on a symmetry point on the pixel value in the target reference region, performing weighted calculation on the pixel value in the target reference region, and performing intra prediction processing based on the pixel value in the target reference region.

In some embodiments, the search region is a preset region including a co-located block of the current block in the reference frame. The search region includes at least one reference block corresponding to the foregoing at least one candidate motion vector.

In some embodiments, each reference block corresponds to one search region. The search region of each reference block includes at least one of the following regions: a pixel region in a specific quantity of rows (for example, 1, 2, 3, 4, 5, and 6) located above the reference block; a pixel region in a specific quantity of rows located below the reference block; a pixel region in a specific quantity of columns located to the left of the reference block; a pixel region in a specific quantity of columns located to the right of the reference block; a pixel region adjacent to an upper left corner of the reference block; a pixel region adjacent to an upper right corner of the reference block; a pixel region adjacent to a lower left corner of the reference block; or a pixel region adjacent to a lower right corner of the reference block.

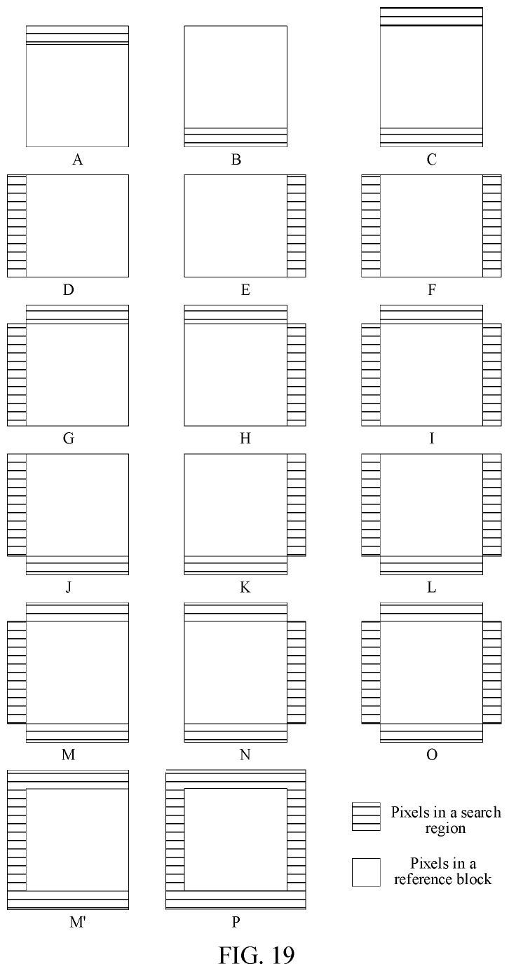

In some embodiments, as shown in FIG. 19, the search region may be set in a plurality of modes (Mode A to Mode P in FIG. 19 are merely examples). In some embodiments, the search region may further include pixel regions at an upper left corner, an upper right corner, a lower left corner, and a lower right corner in Mode A to Mode O shown in FIG. 19. As shown in FIG. 19, Mode M is used as an example. If the pixel regions at the upper left corner and the lower left corner are included, the search region may be illustrated as Mode M′ in FIG. 19. Mode O in FIG. 19 is used as another example. If the pixel regions at the upper left corner, the upper right corner, the lower left corner, and the lower right corner are included, the search region may be illustrated as Mode P in FIG. 19. In some embodiments, the pixel value in the search region may come from the pixels in the reference frame. In other words, the pixel value is directly read from the reference frame, and no additional mode is needed for filling.

In some embodiments, a region range of the second extension region may be determined based on at least one of the following information: a position of the matching block, a quantity of taps of the interpolation filter, and a region range of the search region. Various examples are provided below.

In an embodiment of this disclosure, when the region range of the second extension region is determined, if pixels needed for performing interpolation processing to obtain the matching block extend beyond the region range of the search region, the search region may be further extended, to obtain the second extension region. If the pixels needed for performing the interpolation processing to obtain the matching block are located within the region range of the search region, the interpolation filtering processing may be implemented without extending the search region.

In some embodiments, that the search region is extended to obtain the second extension region may be performed by using a pixel region in a fifth quantity of rows located above the search region and a pixel region in a sixth quantity of rows located below the search region as the region range of the second extension region when an absolute difference (namely, an absolute value of a difference) between a horizontal coordinate of an upper-left vertex of the reference block and a horizontal coordinate of an upper-left vertex of the matching block is less than or equal to a first threshold, and an absolute difference between a vertical coordinate of the upper-left vertex of the reference block and a vertical coordinate of the upper-left vertex of the matching block is greater than a second threshold. In some embodiments, the fifth quantity and the sixth quantity may be equal, or may not be equal, and for example, may be selected from 1, 2, 3, 4, 5, and 6. The first threshold may be a difference between half of a quantity of taps of an interpolation filter used in a horizontal direction during the motion compensation and a set constant value. The second threshold may be a difference between half of a quantity of taps of an interpolation filter used in a vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the quantity of taps is 4, the fifth quantity may be 1, and the sixth quantity may be 2. If the quantity of taps is 6, the fifth quantity may be 2, and the sixth quantity may be 3. If the quantity of taps is 8, the fifth quantity may be 3, and the sixth quantity may be 4. If the quantity of taps is 12, the fifth quantity may be 5, and the sixth quantity may be 6.

In some embodiments, if the absolute difference between the horizontal coordinate of the upper-left vertex of the reference block and the horizontal coordinate of the upper-left vertex of the matching block is less than or equal to the first threshold, the absolute difference between the vertical coordinate of the upper-left vertex of the reference block and the vertical coordinate of the upper-left vertex of the matching block is greater than the second threshold, and a difference between the vertical coordinate of the upper-left vertex of the reference block and the vertical coordinate of the upper-left vertex of the matching block is greater than 0, a pixel region in the fifth quantity of rows located above the search region is used as the region range of the second extension region. In some embodiments, the fifth quantity may be selected from 1, 2, 3, 4, 5, 6, and the like. The first threshold may be a difference between half of a quantity of taps of an interpolation filter used in a horizontal direction during the motion compensation and a set constant value. The second threshold may be a difference between half of a quantity of taps of an interpolation filter used in a vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the quantity of taps is 4, the fifth quantity may be 1. If the quantity of taps is 6, the fifth quantity may be 2. If the quantity of taps is 8, the fifth quantity may be 3. If the quantity of taps is 12, the fifth quantity may be 5.

In some embodiments, if the absolute difference between the horizontal coordinate of the upper-left vertex of the reference block and the horizontal coordinate of the upper-left vertex of the matching block is less than or equal to the first threshold, the absolute difference between the vertical coordinate of the upper-left vertex of the reference block and the vertical coordinate of the upper-left vertex of the matching block is greater than a second threshold, and the difference between the vertical coordinate of the upper-left vertex of the reference block and the vertical coordinate of the upper-left vertex of the matching block is less than or equal to 0, a pixel region in the sixth quantity of rows located below the search region is used as the region range of the second extension region. In some embodiments, the sixth quantity may be selected from 1, 2, 3, 4, 5, 6, and the like. The first threshold may be a difference between half of a quantity of taps of an interpolation filter used in a horizontal direction during the motion compensation and a set constant value. The second threshold may be a difference between half of a quantity of taps of an interpolation filter used in a vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the quantity of taps is 4, the sixth quantity may be 2. If the quantity of taps is 6, the sixth quantity may be 3. If the quantity of taps is 8, the sixth quantity may be 4. If the quantity of taps is 12, the sixth quantity may be 6.

In some embodiments, that the search region is extended to obtain the second extension region may be performed by using a pixel region in a seventh quantity of columns located to the left of the search region and a pixel region in an eighth quantity of columns located to the right of the search region as the region range of the second extension region when the absolute difference between the vertical coordinate of the upper-left vertex of the reference block and the vertical coordinate of the upper-left vertex of the matching block is less than or equal to a third threshold, and the absolute difference between the horizontal coordinate of the upper-left vertex of the reference block and the horizontal coordinate of the upper-left vertex of the matching block is greater than a fourth threshold. In some embodiments, the seventh quantity and the eighth quantity may be equal, or may not be equal, and for example, may be selected from 1, 2, 3, 4, 5, and 6. In some embodiments, the third threshold may be the difference between half of the quantity of taps of the interpolation filter used in the vertical direction during the motion compensation and the set constant value. The fourth threshold may be the difference between half of the quantity of taps of the interpolation filter used in the horizontal direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the quantity of taps is 4, the seventh quantity may be 1, and the eighth quantity may be 2. If the quantity of taps is 6, the seventh quantity may be 2, and the eighth quantity may be 3. If the quantity of taps is 8, the seventh quantity may be 3, and the eighth quantity may be 4. If the quantity of taps is 12, the seventh quantity may be 5, and the eighth quantity may be 6.

In some embodiments, if the absolute difference between the vertical coordinate of the upper-left vertex of the reference block and the vertical coordinate of the upper-left vertex of the matching block is less than or equal to the third threshold, the absolute difference between the horizontal coordinate of the upper-left vertex of the reference block and the horizontal coordinate of the upper-left vertex of the matching block is greater than the fourth threshold, and the difference between the horizontal coordinate of the upper-left vertex of the reference block and the horizontal coordinate of the upper-left vertex of the matching block is greater than 0, a pixel region in the seventh quantity of columns located to the left of the search region is used as the region range of the second extension region. In some embodiments, the seventh quantity may be selected from 1, 2, 3, 4, 5, 6, and the like. In some embodiments, the third threshold may be the difference between half of the quantity of taps of the interpolation filter used in the vertical direction during the motion compensation and the set constant value. The fourth threshold may be the difference between half of the quantity of taps of the interpolation filter used in the horizontal direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the quantity of taps is 4, the seventh quantity may be 1. If the quantity of taps is 6, the seventh quantity may be 2. If the quantity of taps is 8, the seventh quantity may be 3. If the quantity of taps is 12, the seventh quantity may be 5.

In some embodiments, if the absolute difference between the vertical coordinate of the upper-left vertex of the reference block and the vertical coordinate of the upper-left vertex of the matching block is less than or equal to the third threshold, the absolute difference between the horizontal coordinate of the upper-left vertex of the reference block and the horizontal coordinate of the upper-left vertex of the matching block is greater than the fourth threshold, and the difference between the horizontal coordinate of the upper-left vertex of the reference block and the horizontal coordinate of the upper-left vertex of the matching block is less than or equal to 0, a pixel region located in the eighth quantity column to the right of the search region is used as the region range of the second extension region. In some embodiments, the eighth quantity may be selected from 1, 2, 3, 4, 5, 6, and the like. In some embodiments, the third threshold may be the difference between half of the quantity of taps of the interpolation filter used in the vertical direction during the motion compensation and the set constant value. The fourth threshold may be the difference between half of the quantity of taps of the interpolation filter used in the horizontal direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the quantity of taps is 4, the eighth quantity may be 2. If the quantity of taps is 6, the eighth quantity may be 3. If the quantity of taps is 8, the eighth quantity may be 4. If the quantity of taps is 12, the eighth quantity may be 6.

In some embodiments, that the search region is extended to obtain the second extension region may be performed by using the pixel region in the fifth quantity of rows located above the search region, the pixel region in the sixth quantity of rows located below the search region, the pixel region in the seventh quantity of columns located to the left of the search region, and the pixel region in the eighth quantity of columns located to the right of the search region as the region range of the second extension region when the absolute difference between the horizontal coordinate of the upper-left vertex of the reference block and the horizontal coordinate of the upper-left vertex of the matching block is greater than a fifth threshold, and the absolute difference between the vertical coordinate of the upper-left vertex of the reference block and the vertical coordinate of the upper-left vertex of the matching block is greater than a sixth threshold. In some embodiments, the fifth quantity, the sixth quantity, the seventh quantity, and the eighth quantity may be equal, or may not be equal, or may be partially equal, and for example, may be selected from 1, 2, 3, 4, 5, and 6. In some embodiments, the fifth threshold may be the difference between half of the quantity of taps of the interpolation filter used in the horizontal direction during the motion compensation and the set constant value. The sixth threshold may be the difference between half of the quantity of taps of the interpolation filter used in the vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the absolute difference between the horizontal coordinate of the upper-left vertex of the reference block and the horizontal coordinate of the upper-left vertex of the matching block is greater than the fifth threshold, the absolute difference between the vertical coordinate of the upper-left vertex of the reference block and the vertical coordinate of the upper-left vertex of the matching block is greater than the sixth threshold, and the difference between the vertical coordinate of the upper-left vertex of the reference block and the vertical coordinate of the upper-left vertex of the matching block is greater than 0, the pixel region in the fifth quantity of rows located above the search region is used as the region range of the second extension region. In some embodiments, the fifth quantity may be selected from 1, 2, 3, 4, 5, 6, and the like. In some embodiments, the fifth threshold may be the difference between half of the quantity of taps of the interpolation filter used in the horizontal direction during the motion compensation and the set constant value. The sixth threshold may be the difference between half of the quantity of taps of the interpolation filter used in the vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the absolute difference between the horizontal coordinate of the upper-left vertex of the reference block and the horizontal coordinate of the upper-left vertex of the matching block is greater than the fifth threshold, the absolute difference between the vertical coordinate of the upper-left vertex of the reference block and the vertical coordinate of the upper-left vertex of the matching block is greater than the sixth threshold, and a difference between the vertical coordinate of the upper-left vertex of the reference block and the vertical coordinate of the upper-left vertex of the matching block is less than or equal to 0, the pixel region in the sixth quantity of rows located below the search region is used as the region range of the second extension region. In some embodiments, the sixth quantity may be selected from 1, 2, 3, 4, 5, 6, and the like. In some embodiments, the fifth threshold may be the difference between half of the quantity of taps of the interpolation filter used in the horizontal direction during the motion compensation and the set constant value. The sixth threshold may be the difference between half of the quantity of taps of the interpolation filter used in the vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the absolute difference between the horizontal coordinate of the upper-left vertex of the reference block and the horizontal coordinate of the upper-left vertex of the matching block is greater than the fifth threshold, the absolute difference between the vertical coordinate of the upper-left vertex of the reference block and the vertical coordinate of the upper-left vertex of the matching block is greater than the sixth threshold, and the difference between the horizontal coordinate of the upper-left vertex of the reference block and the horizontal coordinate of the upper-left vertex of the matching block is greater than 0, the pixel region in the seventh quantity of columns located to the left of the search region is used as the region range of the second extension region. In some embodiments, the seventh quantity may be selected from 1, 2, 3, 4, 5, 6, and the like. In some embodiments, the fifth threshold may be the difference between half of the quantity of taps of the interpolation filter used in the horizontal direction during the motion compensation and the set constant value. The sixth threshold may be the difference between half of the quantity of taps of the interpolation filter used in the vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

In some embodiments, if the absolute difference between the horizontal coordinate of the upper-left vertex of the reference block and the horizontal coordinate of the upper-left vertex of the matching block is greater than the fifth threshold, the absolute difference between the vertical coordinate of the upper-left vertex of the reference block and the vertical coordinate of the upper-left vertex of the matching block is greater than the sixth threshold, and the difference between the horizontal coordinate of the upper-left vertex of the reference block and the horizontal coordinate of the upper-left vertex of the matching block is less than or equal to 0, the pixel region in the eighth quantity of columns located to the right of the search region is used as the region range of the second extension region. In some embodiments, the eighth quantity may be selected from 1, 2, 3, 4, 5, 6, and the like. In some embodiments, the fifth threshold may be the difference between half of the quantity of taps of the interpolation filter used in the horizontal direction during the motion compensation and the set constant value. The sixth threshold may be the difference between half of the quantity of taps of the interpolation filter used in the vertical direction during the motion compensation and the set constant value. The set constant value may be, for example, 1 or another value. The quantity of taps of the interpolation filter used in the horizontal direction during the motion compensation may be equal to or may be different from the quantity of taps used in the vertical direction.

The upper-left vertex in the foregoing embodiment is merely an example. Alternatively, upper-right vertexes, lower-left vertexes, lower-right vertexes, and center points of the block in the reference block and the matching block may also be used, or coordinate points at any same position in the reference block and the matching block may also be used.

Based on the foregoing embodiment, it is assumed that coordinates of the current block (for example, coordinates of the upper-left vertex of the current block) are (x, y), a width of the current block is w, a height of the current block is h, and an initial MV and an optimal MV for inter TM are respectively

$$( m {v}_{x}^{1} , {mv}_{y}^{1} ) and ( {mv}_{x}^{2} , {mv}_{y}^{2} ) .$$

Because positions of the reference block and the optimal matching block are different, the second extension region may be determined in the following manner.

When

$$\vert {mv}_{x}^{1} - {mv}_{x}^{2} \vert \leq \frac{{T}_{1}}{2} - 1 , \vert {mv}_{y}^{1} - {mv}_{y}^{2} \vert > \frac{{T}_{2}}{2} - 1 ,$$

the second extension region may be obtained based on that the search region is extended upward only by I pixels (namely, extended upward by I rows of pixels) and extended downward by J pixels (namely, extended downward by J rows of pixels). In some embodiments, under the foregoing condition, when

$${mv}_{y}^{1} - {mv}_{y}^{2} > 0 ,$$

the search region may be extended upward only by only I pixels. When

$${mv}_{y}^{1} - {mv}_{y}^{2} \leq 0 ,$$

the search region may be extended downward only by only J pixels.

When

$${mv}_{y}^{1} - {mv}_{y}^{2} \vert \leq \frac{{T}_{2}}{2} - 1 , \vert {mv}_{x}^{1} - {mv}_{x}^{2} \vert > \frac{{T}_{1}}{2} - 1 ,$$

the second extension region may be obtained based on that the search region is extended leftward only by I pixels (namely, extended leftward by I columns of pixels) and extended rightward by J pixels (namely, extended rightward by J columns of pixels). In some embodiments, under the foregoing condition, when

$${mv}_{x}^{1} - {mv}_{x}^{2} > 0 ,$$

the search region may be extended leftward only by I pixels. When

$${mv}_{x}^{1} - {mv}_{x}^{2} \leq 0 ,$$

the search region may be extended rightward only by only J pixels.

When

$$\vert {mv}_{x}^{1} - {mv}_{x}^{2} \vert > \frac{{T}_{1}}{2} - 1 , \vert {mv}_{y}^{1} - {mv}_{y}^{2} \vert > \frac{{T}_{2}}{2} - 1 ,$$

the second extension region may be obtained based on that the search region is extended upward by I1 pixels and downward by J1 pixels (namely, extended upward by I1 rows of pixels, and extended downward by J1 rows of pixels), and extended leftward by I2 pixels and rightward by J2 pixels (namely, extended leftward by I2 columns of pixels, and extended rightward by J2 columns of pixels). In some embodiments, under the foregoing condition, when

$${mv}_{x}^{1} - {mv}_{x}^{2} > 0 ,$$

the search region may be extended leftward only by I2 pixels; under the foregoing condition, when

$${mv}_{x}^{1} - {mv}_{x}^{2} \leq 0 ,$$

the search region may be extended rightward only by J2 pixels; under the foregoing condition, when

$${mv}_{y}^{1} - {mv}_{y}^{2} > 0 ,$$

the search region may be extended upward only by I1 pixels; under the foregoing condition, when

$${mv}_{y}^{1} - {mv}_{y}^{2} \leq 0 ,$$

the search region may be extended downward only by J1 pixels.

When

$$\vert {mv}_{x}^{1} - {mv}_{x}^{2} \vert \leq \frac{{T}_{1}}{2} - 1 , \vert {mv}_{y}^{1} - {mv}_{y}^{2} \vert \leq \frac{{T}_{2}}{2} - 1 ,$$

the second extension region does not extend beyond a boundary of the search region. In other words, the pixel does not need to be extended.

In the foregoing examples, I, J, I1, J1, I2, and J2 are all positive integers. T1 represents a quantity of taps of the interpolation filter used in the horizontal direction during the motion compensation, and T2 represents a quantity of taps of the interpolation filter used in the vertical direction during the motion compensation.

In an embodiment of this disclosure, if the second extension region is determined based on the region range of the search region, the region range of the second extension region may be determined by using at least one of the following regions: a pixel region in a ninth quantity of rows located above the search region, a pixel region in a tenth quantity of rows located below the search region, a pixel region in an eleventh quantity of columns located to the left of the search region, a pixel region in a twelfth quantity of columns located to the right of the search region, a pixel region located in the upper left of the search region, a pixel region located in the upper right of the search region, a pixel region located in the lower left of the search region, or a pixel region located in the lower right of the search region.

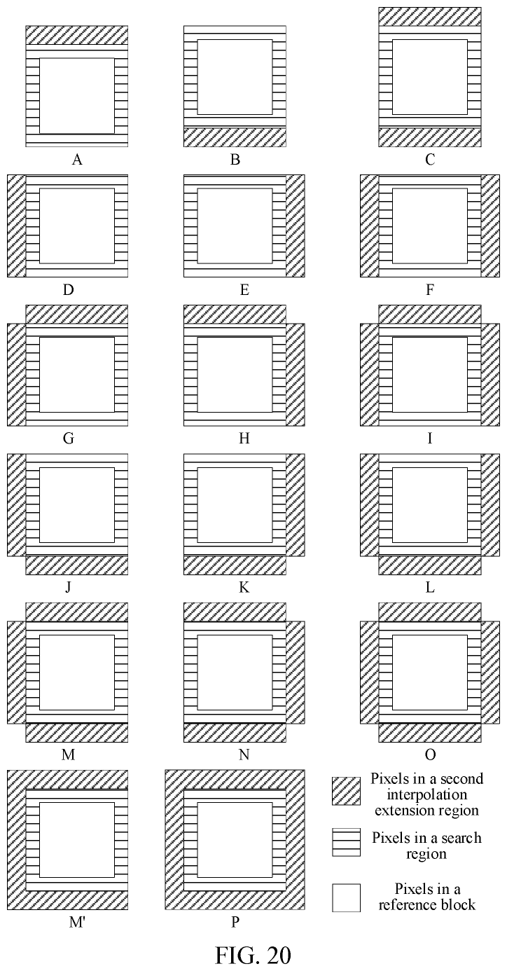

In some embodiments, as shown in FIG. 20, the second extension region may be set in a plurality of modes (setting modes in FIG. 20 are described by using an example in which the search region surrounds the reference block, and the modes in FIG. 20 are merely examples). In other words, the second extension region may be located on at least one side of the search region, including above, below, to the left, or to the right thereof. In some embodiments, the second extension region may further include pixel regions at one or more of an upper left corner, an upper right corner, a lower left corner, or a lower right corner in Mode A to Mode O shown in FIG. 20. As shown in FIG. 20, Mode Mis used as an example. If pixel regions at the upper left corner and the lower left corner are included, the second extension region may be illustrated as Mode M′ in FIG. 20. Mode O shown in FIG. 20 is used as another example. If pixel regions at the upper left corner, the upper right corner, the lower left corner, and the lower right corner are included, the second extension region may be illustrated as Mode P in FIG. 20.

In an embodiment of this disclosure, if the second extension region is determined based on the quantity of taps of the interpolation filter used during the motion compensation, when the quantity of taps of the interpolation filter used during the motion compensation is 4, a pixel region in 1 row located above the search region, a pixel region in 2 rows located below the search region, a pixel region in 1 column located to the left of the search region, and a pixel region in 2 columns located to the right of the search region are used as the region range of the second extension region. Specific numerical values in this embodiment are merely examples.

In an embodiment of this disclosure, if the second extension region is determined based on the quantity of taps of the interpolation filter used during the motion compensation, when the quantity of taps of the interpolation filter used during the motion compensation is 6, a pixel region in 2 rows located above the search region, a pixel region in 3 rows located below the search region, a pixel region in 2 columns located to the left of the search region, and a pixel region in 3 columns located to the right of the search region are used as the region range of the second extension region. Specific numerical values in this embodiment are merely examples.

In an embodiment of this disclosure, if the second extension region is determined based on the quantity of taps of the interpolation filter used during the motion compensation, when the quantity of taps of the interpolation filter used during the motion compensation is 8, a pixel region in 3 rows located above the search region, a pixel region in 4 rows located below the search region, a pixel region in 3 columns located to the left of the search region, and a pixel region in 4 columns located to the right of the search region are used as the region range of the second extension region. Specific numerical values in this embodiment are merely examples.

In an embodiment of this disclosure, if the second extension region is determined based on the quantity of taps of the interpolation filter used during the motion compensation, when the quantity of taps of the interpolation filter used during the motion compensation is 12, a pixel region in 5 rows located above the search region, a pixel region in 6 rows located below the search region, a pixel region in 5 columns located to the left of the search region, and a pixel region in 6 columns located to the right of the search region are used as the region range of the second extension region. Specific numerical values in this embodiment are merely examples.

In an embodiment of this disclosure, if the second extension region is determined based on the quantity of taps of the interpolation filter used during the motion compensation, when the quantity of taps of the interpolation filter used during the motion compensation is 12, a pixel region in 5 columns located to the left of the search region, and a pixel region in 6 columns located to the right of the search region are used as the region range of the second extension region. Specific numerical values in this embodiment are merely examples.

In an embodiment of this disclosure, if the second extension region is determined based on the quantity of taps of the interpolation filter used during the motion compensation, when the quantity of taps of the interpolation filter used during the motion compensation is 12, a pixel region in 5 rows located above the search region, and a pixel region in 6 rows located below the search region are used as the region range of the second extension region. Specific numerical values in this embodiment are merely examples.

In some embodiments, if coordinates of a reference block extend beyond a picture boundary of a reference frame, the coordinates of the reference block may be adjusted to be on the picture boundary. The picture boundary of the reference frame may be a boundary of a reference frame picture, or may be a boundary after extending the reference frame picture outward by a set size region (for example, a set row and/or a set column).

In some embodiments, if coordinates of a matching block extend beyond the picture boundary of the reference frame, the coordinates of the matching block may be adjusted to be on the picture boundary. The picture boundary of the reference frame may be the boundary of the reference frame picture, or may be the boundary after extending the reference frame picture outward by the set size region (for example, the set row and/or the set column).

In some embodiments, if the search region extends beyond the picture boundary of the reference frame, the boundary of the search region may be adjusted to be on the picture boundary. The picture boundary of the reference frame may be the boundary of the reference frame picture, or may be the boundary after extending the reference frame picture outward by the set size region (for example, the set row and/or the set column).

In an example, it is assumed that coordinates of the current block (for example, coordinates of an upper-left vertex of the current block) are (x, y), a width of the current block is w, a height of the current block is h, and an initial MV and an optimal MV for inter TM are respectively

$$( {mv}_{x}^{1} , {mv}_{y}^{1} ) and ( {mv}_{x}^{2} , {mv}_{y}^{2} ) .$$

Then upper-left coordinates, upper-right coordinates, lower-left coordinates, and lower-right coordinates of the reference block of the current block are respectively

$$( x + {mv}_{x}^{1} , y + {my}_{y}^{1} ) , ( x + w + {mv}_{x}^{1} , y + {mv}_{y}^{1} ) , ( x + m {v}_{x}^{1} , y + h + {mv}_{y}^{1} ) , and$$

$$( x + w + {mv}_{x}^{1} , y + h + {mv}_{y}^{1} ) ,$$

and upper-left coordinates, upper-right coordinates, lower-left coordinates, and lower-right coordinates of an optimal matching block corresponding to the optimal MV are respectively

$$( x + {mv}_{x}^{2} , y + {my}_{y}^{2} ) , ( x + w + {mv}_{x}^{2} , y + {mv}_{y}^{2} ) , ( x + m {v}_{x}^{2} , y + h + {mv}_{y}^{2} ) , and$$

$$( x + w + {mv}_{x}^{2} , y + h + {mv}_{y}^{2} ) .$$

Neither of these coordinate values can exceed the picture boundary, which may also be understood as that neither the reference block nor the optimal matching block can extend beyond the picture boundary. In some embodiments, the picture boundary may be a current encoded picture boundary, or a boundary after extending the current encoded picture outward by N1 pixel units. N1 is a positive integer (for example, a boundary after extending the current encoded picture outward by a length of one CTU).

If neither the coordinates of the reference block nor the coordinates of the optimal matching block extend beyond the picture boundary, TM and pixel interpolation are normally performed. On the contrary, coordinates beyond the picture boundary are adjusted to be a position of the current picture boundary. In addition, the coordinates of the optimal matching block may be on a boundary of the search region. Therefore, the boundary of the search region cannot extend beyond the picture boundary either.

In some embodiments, a quantity of taps of a first interpolation filter that performs interpolation filtering processing on the template prediction region, and a quantity of taps of a second interpolation filter that performs interpolation filtering processing to obtain the matching block are respectively selected from the following quantities of taps: 1, 2, 4, 6, 8, and 12. Alternatively, the first interpolation filter and the second interpolation filter may perform interpolation by using nearest neighbor interpolation, bilinear interpolation, bicubic interpolation, or the like. In some embodiments, the nearest neighbor interpolation, the bilinear interpolation, and the bicubic interpolation may be respectively considered as a 1-tap interpolation filter, a 2-tap interpolation filter, and a 4-tap interpolation filter.

The quantity of taps of the first interpolation filter is the same as or different from the quantity of taps of the second interpolation filter. For example, the first interpolation filter may be a 12-tap interpolation filter, and the second interpolation filter may also be a 12-tap interpolation filter. Alternatively, the first interpolation filter may be a 6-tap interpolation filter, and the second interpolation filter may be a 12-tap interpolation filter.

In some examples, a first quantity of taps of a first interpolation filter in the first interpolation filtering processing and a second quantity of taps of a second interpolation filter used in the second interpolation filtering processing may be determined based on exchanging information with an encoding entity. In some examples, the bitstream is decoded to obtain control information indicating the first quantity of taps of the first interpolation filter in the first interpolation filtering processing and the second quantity of taps of the second interpolation filter used in the second interpolation filtering processing. In some embodiments, when the technical solutions of one or more embodiments of this disclosure are applied, a decoder end may determine, based on a manner of negotiation with an encoder end, a quantity of taps of an interpolation filter used in inter TM and a quantity of taps of an interpolation filter used during the motion compensation. For example, considering that an inter TM process does not need an excessively high-accuracy interpolation filter, and the motion compensation process demands that a finally obtained matching block is as good as possible, a codec may use, in the inter TM process by default, a 6-tap interpolation filter that fills an interpolation extension region based on existing pixels (namely, the solution provided in one or more embodiments of this disclosure of using pixels in a template prediction region to fill a first extension region), and use, during the motion compensation, a 12-tap interpolation filter that fills the interpolation extension region based on existing pixels (namely, the solution provided in one or more embodiments of this disclosure of using pixels in a search region and/or in a reference block to fill a second extension region).

In some embodiments, when the technical solutions of one or more embodiments of this disclosure are applied, the decoder end may decode a video bitstream to obtain at least one flag bit, and then determine, based on a value of the at least one flag bit, the quantity of taps of the interpolation filter used in the inter TM process and a quantity of taps of the interpolation filter used during the motion compensation. In some embodiments, the at least one flag bit includes one or more of the following flag bits: a flag bit included in a sequence header, a flag bit included in a picture header, a flag bit included in a slice header, a flag bit included in a CTU header, or a flag bit included in a coding block.

In an example, the encoder end may adaptively select an optimal interpolation filtering method in each process through RDO, and indicate a specific mode to be used through one or more of a block-level flag bit, a CTU-level flag bit, a slice-level flag bit, a frame-level flag bit, or a sequence-level flag bit, so that the decoder end may directly parse the flag bit and obtain a corresponding processing mode. For example, the encoder end may use 2 flag bits, where a value of one flag bit is configured for indicating the quantity of taps of the interpolation filter used in the inter TM process, and a value of one flag bit is configured for indicating the quantity of taps of the interpolation filter used during the motion compensation.

In some embodiments of this disclosure, based on the foregoing solution, the quantity of taps of the interpolation filter used in the horizontal direction during inter TM may be the same as or different from the quantity of taps used in the vertical direction. The quantity of taps of the interpolation filter used in the horizontal direction during the motion compensation may be the same as or different from the quantity of taps used in the vertical direction.

In a specific application scenario of this disclosure, interpolation filters with different quantities of taps such as 1 tap, 2 taps, 4 taps, 6 taps, 8 taps, and 12 taps may be used in both the inter TM process and the motion compensation process. In some embodiments, several specific examples of types of interpolation filters that may be used in the inter TM process and the motion compensation process are shown in Table 1 below.

TABLE 1

| Process type | Inter TM process | Motion compensation process |
|---|---|---|
| Interpolation | Bilinear interpolation | 12-tap interpolation filter |
| filter type | 12-tap interpolation filter | 12-tap interpolation filter |
| | 12-tap interpolation filter | 12-tap interpolation filter |
| | that fills an interpolation | that fills an interpolation |
| | extension region based on | extension region based on |
| | an existing pixel | an existing pixel |
| | 6-tap interpolation filter | 12-tap interpolation filter |
| | that fills an interpolation | that fills an interpolation |
| | extension region based on | extension region based on |
| | an existing pixel | an existing pixel |

In some embodiments, a 12-tap interpolation filter coefficient and a 6-tap interpolation filter coefficient given a ¼ pixel accuracy in the inter TM process may be shown in Table 2 below.

TABLE 2

| MV | 12-tap interpolation | 6-tap interpolation |
|---|---|---|
| position | filter coefficient | filter coefficient |
| 0 | 0, 0, 0, 0, 0, 256, 0, 0, 0, 0, 0, 0 | 0, 0, 256, 0, 0, 0 |
| ¼ | −2, 6, −12, 22, −44, 230, | 10, −36, 229, |
| | 76, −30, 16, −9, 4, −1 | 71, −21, 3 |
| 2/4 | −2, 6, −13, 25, −50, 162, | 9, −38, 157, |
| | 162, −50, 25, −13, 6, −2 | 157, −38, 9 |
| ¾ | −1, 4, −9, 16, −30, 76, | 3, −21, 71, |
| | 230, −44, 22, −12, 6, −2 | 229, −36, 10 |

The solutions in one or more embodiments in this disclosure may be used separately, or may be used in combination. The technical solutions in one or more embodiments of this disclosure may be applied to a search process based on TM technologies such as the intra TM and the inter TM and/or the motion compensation process, and may be applied to a video codec product.

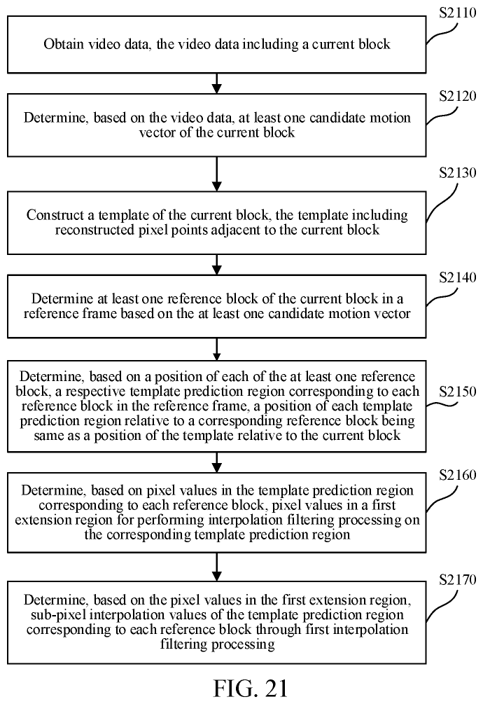

FIG. 21 is a flowchart of a video encoding method according to an embodiment of this disclosure. The video encoding method may be performed by a device having a computing processing function, for example, may be performed by a terminal device or a server. Referring to FIG. 21, the video encoding method includes at least S2110 to S2170. A detailed description is as follows.

S2110: Obtain video data, the video data including a current block.

S2120: Determine, based on the video data, at least one candidate motion vector for inter TM of the current block.

S2130: Construct a template of the current block, the template including pixel points adjacent to the current block.

S2140: Determine at least one reference block of the current block in a reference frame based on the at least one candidate motion vector.

S2150: Determine, based on a position of each of the at least one reference block, a respective template prediction region corresponding to each reference block in the reference frame, a position of each template prediction region relative to a corresponding reference block being the same as a position of the template relative to the current block.

S2160: Determine, based on a pixel value in the template prediction region corresponding to each reference block, a pixel value in a first extension region for performing interpolation filtering processing on the corresponding template prediction region. For example, based on pixel values in the template prediction region corresponding to each reference block, pixel values in a respective first extension region outside the corresponding template prediction region are determined.

S2170: Determine, based on the pixel value in the first extension region, sub-pixel interpolation of the corresponding template prediction region through the interpolation filtering processing, to serve as a predicted value of a template corresponding to the corresponding template prediction region. For example, based on the pixel values in the first extension region, sub-pixel interpolation values of the template prediction region corresponding to each reference block are determined through first interpolation filtering processing.

In some examples, a target motion vector is searched through an inter-frame template match process based on the template of the current block and the sub-pixel interpolation values of the template prediction region corresponding to each reference block. In some examples, pixel values of a matching block are determined based on the target motion vector. In some examples, the current block is encoded into a bitstream based on the pixel values of the matching block. In some examples, the encoded bitstream is transmitted.

A processing process on the encoder end is similar to a processing process on the decoder end. For details, reference may be made to the foregoing processing process related to the decoder end. Details are not described herein again.

An apparatus embodiment of this disclosure is described below, which may be configured for performing the method in the foregoing embodiment of this disclosure. For details not disclosed in the apparatus embodiment of this disclosure, reference may be made to the foregoing method embodiment of this disclosure.

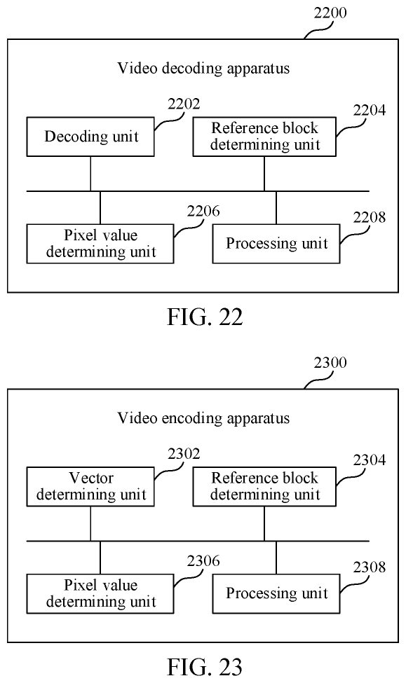

FIG. 22 is a block diagram of a video decoding apparatus according to an embodiment of this disclosure. The video decoding apparatus may be arranged in a device having a computing processing function, for example, may be arranged in a terminal device or a server.

Referring to FIG. 22, a video decoding apparatus 2200 according to an embodiment of this disclosure includes a decoding unit 2202, a reference block determining unit 2204, a pixel value determining unit 2206, and a processing unit 2208.

The decoding unit 2202 is configured to: receive a video bitstream, determine at least one candidate motion vector for inter TM of a current block based on the video bitstream; and construct a template of the current block, the template including reconstructed pixel points adjacent to the current block. The reference block determining unit 2204 is configured to determine at least one reference block of the current block in a reference frame based on the at least one candidate motion vector. The pixel value determining unit 2206 is configured to: determine, based on a position of each of the at least one reference block, a template prediction region corresponding to each reference block in the reference frame, a position of each template prediction region relative to a corresponding reference block being the same as a position of the template relative to the current block; and determine, based on a pixel value in the template prediction region corresponding to each reference block, a pixel value in a first extension region for performing interpolation filtering processing on the corresponding template prediction region. The processing unit 2208 is configured to determine, based on the pixel value in the first extension region, sub-pixel interpolation of the corresponding template prediction region through the interpolation filtering processing, to serve as a predicted value of a template corresponding to the corresponding template prediction region.

In some embodiments of this disclosure, based on the foregoing solution, the video decoding apparatus 2200 further includes: a search unit, configured to determine an optimal motion vector corresponding to the at least one candidate motion vector through the inter TM based on the sub-pixel interpolation of the template prediction region corresponding to each reference block, and determine a matching block of the current block based on the optimal motion vector; and a filtering unit, configured to perform interpolation filtering processing to obtain the matching block.

In some embodiments of this disclosure, based on the foregoing solution, the filtering unit is configured to: determine, based on a pixel value in a target reference region in the reference frame, a pixel value in a second extension region for interpolation filtering processing during the motion compensation, and perform interpolation filtering processing to obtain the matching block based on the second extension region.

In some embodiments of this disclosure, based on the foregoing solution, the set region includes at least one of the following regions: a first pixel position included in a search region in the reference frame, or a second pixel position in a reference block corresponding to the matching block.

In some embodiments of this disclosure, based on the foregoing solution, a quantity of taps of a first interpolation filter that performs interpolation filtering processing on the template prediction region, and a quantity of taps of a second interpolation filter that performs interpolation filtering processing to obtain the matching block are respectively selected from the following quantities of taps: 1, 2, 4, 6, 8, and 12; and
the quantity of taps of the first interpolation filter is the same as or different from the quantity of taps of the second interpolation filter.

In some embodiments of this disclosure, based on the foregoing solution, the first interpolation filter is a 12-tap interpolation filter, and the second interpolation filter is a 12-tap interpolation filter; or
the first interpolation filter is a 6-tap interpolation filter, and the second interpolation filter is a 12-tap interpolation filter.

In some embodiments of this disclosure, based on the foregoing solution, the template prediction region includes a pixel region located above the reference block and a pixel region located to the left of the reference block. The first extension region includes at least one of the following regions:
a pixel region in a first quantity of rows located above the template prediction region;
a pixel region in a second quantity of rows below the template prediction region;
a pixel region in a third quantity of columns to a left side of the template prediction region;
a pixel region in a fourth quantity of columns to a right side of the template prediction region;
a pixel region adjacent to an upper left corner of the template prediction region;
a pixel region adjacent to an upper right corner of the template prediction region;
a pixel region adjacent to a lower left corner of the template prediction region; or
a pixel region adjacent to a lower right corner of the template prediction region.

In some embodiments of this disclosure, based on the foregoing solution, the pixel value determining unit 2206 is configured to determine the pixel value in the first extension region for performing interpolation filtering processing in the inter TM process based on at least one of the following manners:
copying the pixel value in the template prediction region, to serve as the pixel value in the first extension region;
performing replication on the pixel value in the template prediction region based on an axis of symmetry, to obtain the pixel value in the first extension region;
performing replication on the pixel value in the template prediction region based on a symmetry point, to obtain the pixel value in the first extension region;
performing weighted calculation on the pixel value in the template prediction region, to obtain the pixel value in the first extension region; or
performing intra prediction processing based on the pixel value in the template prediction region, to obtain the pixel value in the first extension region.

In some embodiments of this disclosure, based on the foregoing solution, the processing unit 2208 is further configured to: determine, based on a manner of negotiation with an encoder end, a quantity of taps of an interpolation filter used in the inter TM, and a quantity of taps of an interpolation filter used in the motion compensation; or
decode the video bitstream to obtain at least one flag bit, and determine, based on a value of the at least one flag bit, the quantity of taps of the interpolation filter used in the inter TM process and the quantity of taps of the interpolation filter used during the motion compensation.

In some embodiments of this disclosure, based on the foregoing solution, the at least one flag bit includes one or more of the following flag bits: a flag bit included in a sequence header, a flag bit included in a picture header, a flag bit included in a slice header, a flag bit included in a CTU header, and a flag bit included in a coding block.

In some embodiments of this disclosure, based on the foregoing solution, the quantity of taps of the interpolation filter used in the horizontal direction during inter TM is the same as or different from the quantity of taps used in the vertical direction. The quantity of taps of the interpolation filter used in the horizontal direction during the motion compensation is the same as or different from the quantity of taps used in the vertical direction.

FIG. 23 is a block diagram of a video encoding apparatus according to an embodiment of this disclosure. The video encoding apparatus may be arranged in a device having a computing processing function, for example, may be arranged in a terminal device or a server.

Referring to FIG. 23, a video encoding apparatus 2300 according to an embodiment of this disclosure includes a vector determining unit 2302, a reference block determining unit 2304, a pixel value determining unit 2306, and a processing unit 2308.

The vector determining unit 2302 is configured to: obtain video data, the video data including a current block; determine, based on the video data, at least one candidate motion vector for inter TM of the current block; and construct a template of the current block, the template including pixel points adjacent to the current block. The reference block determining unit 2304 is configured to determine at least one reference block of the current block in a reference frame based on the at least one candidate motion vector. The pixel value determining unit 2306 is configured to: determine, based on a position of each of the at least one reference block, a template prediction region corresponding to each reference block in the reference frame, a position of each template prediction region relative to a corresponding reference block being the same as a position of the template relative to the current block; and determine, based on a pixel value in the template prediction region corresponding to each reference block, a pixel value in a first extension region for performing interpolation filtering processing on the corresponding template prediction region. The processing unit 2308 is configured to determine, based on the pixel value in the first extension region, sub-pixel interpolation of the corresponding template prediction region through the interpolation filtering processing, to serve as a predicted value of a template corresponding to the corresponding template prediction region.

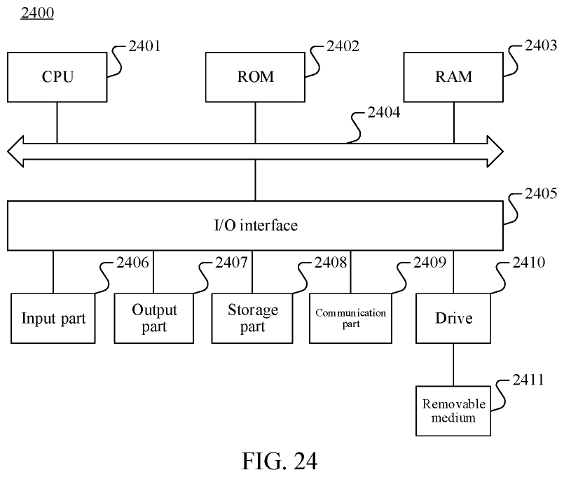

FIG. 24 is a schematic structural diagram of a computer system configured to implement an electronic device according to an embodiment of this disclosure. The electronic device may be the video encoding apparatus or the video decoding apparatus in one or more embodiments in this disclosure.

A computer system 2400 of the electronic device shown in FIG. 24 is merely an example, and does not constitute any limitation on a function or a usage scope of one or more embodiments of this disclosure.

As shown in FIG. 24, the computer system 2400 may include processing circuitry such as a central processing unit (CPU) 2401, which may perform various suitable actions and processes based on a program stored in a read-only memory (ROM) 2402 or a program loaded from a storage part 2408 into a random access memory (RAM) 2403, for example, perform the method in one or more embodiments in this disclosure. The RAM 2403 further has various programs and data required for system operation stored therein. The CPU 2401, the ROM 2402, and the RAM 2403 are connected to each other through a bus 2404. An input/output (I/O) interface 2405 is also connected to the bus 2404.

The following components may be connected to the I/O interface 2405: an input part 2406 including a keyboard, a mouse, or the like; an output part 2407 including a cathode ray tube (CRT), a liquid crystal display (LCD), a speaker, or the like; a storage part 2408 including a hard disk, or the like; and a communication part 2409 including a network interface card such as a LAN card and a modem. The communication part 2409 performs communication processing through a network such as the Internet. A drive 2410 is also connected to the I/O interface 2405 as required. A removable medium 2411, such as a magnetic disk, an optical disc, a magneto-optical disk, or a semiconductor memory is installed on the drive 2410 as required, so that a computer program read from the removable medium is installed into the storage part 2408 as required.

Particularly, according to one or more embodiments of this disclosure, the processes described above with reference to the flowcharts may be implemented as a computer software program. For example, one or more embodiments of this disclosure include a computer program product, the computer program product including a computer program carried on a non-transitory computer-readable storage medium, the computer program being configured to perform the methods shown in the flowcharts. In such an embodiment, the computer program may be downloaded and installed from a network through the communication part 2409, and/or installed from the removable medium 2411. When the computer program is executed by the CPU 2401, various functions defined in the system of this disclosure may be executed.

The non-transitory computer-readable storage medium may be, for example, but is not limited to, an electric, magnetic, optical, electromagnetic, infrared, or semi-conductive system, apparatus, or device, or any combination of the above. A more specific example of the non-transitory computer-readable storage medium may include but is not limited to: an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. In this disclosure, the non-transitory computer-readable storage medium may be any tangible medium that includes a computer program or has a computer program stored therein. The computer program may be used by or used in combination with an instruction execution system, an apparatus, or a device.

Flowcharts and block diagrams in the accompanying drawings illustrate possible system architectures, functions and operations that may be implemented by a system, a method, and a computer program product according to various embodiments of this disclosure. Each block in the flowcharts or the block diagrams may represent a module, a program segment, or a part of code. The module, the program segment, or the part of the code includes one or more executable instructions configured for implementing a specified logical function. In some alternative implementations, functions annotated in the blocks may also be executed in an order different from that annotated in the accompanying drawings. For example, two blocks shown in succession may actually be performed substantially in parallel, or may sometimes be performed in a reverse order, which depends on the functions involved. Each block of the block diagrams or the flowcharts and combinations of blocks in the block diagrams or the flowcharts may be implemented by a dedicated hardware-based system configured to perform specified functions or operations, or may be implemented by a combination of dedicated hardware and a computer program.

The involved units described in one or more embodiments of this disclosure may be implemented by software or hardware, and the described units may alternatively be arranged in a processor. Names of the units do not constitute a limitation on the units in a specific case.

According to another aspect, this disclosure further provides a non-transitory computer-readable storage medium. The non-transitory computer-readable storage medium may be included in the electronic device in one or more embodiments in this disclosure, or may exist alone without being installed into the electronic device. The foregoing non-transitory computer-readable storage medium carries one or more computer programs, the one or more computer programs, when executed by the electronic device, causing the electronic device to implement the methods described in one or more embodiments in this disclosure.

Although a plurality of modules or units of a device configured to perform actions are mentioned in the foregoing detailed descriptions, such division is not mandatory. In some examples, according to the implementations of this disclosure, the features and functions of two or more modules or units described above may be specifically implemented in one module or unit. On the contrary, the features and functions of one module or unit described above may be further divided to be embodied by a plurality of modules or units.

According to the foregoing descriptions of one or more embodiments, a person skilled in the art may readily understand that one or more embodiments described herein may be implemented by software, or may be implemented by combining software and necessary hardware. Therefore, the technical solutions according to the implementations of this disclosure may be embodied in a form of a software product. The software product may be stored in a non-volatile storage medium (which may be a CD-ROM, a USB flash drive, a removable hard disk, or the like) or on a network, including several instructions for causing an electronic device to perform the method according to the implementations of this disclosure.

For example, the electronic device may be a video decoding apparatus, and the video decoding apparatus may perform the video decoding method shown in FIG. 14. For another example, the electronic device may be a video encoding apparatus, and the video encoding apparatus may perform the video encoding method shown in FIG. 21.

A person skilled in the art may derive another implementation of this disclosure without departing from ideas and embodiments in this disclosure. This disclosure is intended to cover any variations, uses, or adaptive changes of this disclosure. These variations, uses, or adaptive changes follow the general principles of this disclosure and shall be within the scope of this disclosure.

This disclosure is not limited to the structures described above and shown in the accompanying drawings, and various modifications and changes may be made without departing from the scope of this disclosure.

What is claimed is:

1. A video decoding method, the method comprising:
determining at least one candidate motion vector of a current block based on a bitstream;
constructing a template of the current block, the template including reconstructed pixel points adjacent to the current block;
determining at least one reference block of the current block in a reference frame based on the at least one candidate motion vector;
determining, based on a position of each of the at least one reference block, a respective template prediction region corresponding to each reference block in the reference frame, a position of each template prediction region relative to a corresponding reference block being same as a position of the template relative to the current block;
determining, based on pixel values in the template prediction region corresponding to each reference block, pixel values in a respective first extension region outside the corresponding template prediction region;
determining, based on the pixel values in the first extension region, sub-pixel interpolation values of the template prediction region corresponding to each reference block through first interpolation filtering processing;
searching for a target motion vector through an inter-frame template match process based on the template of the current block and the sub-pixel interpolation values of the template prediction region corresponding to each reference block;
determining pixel values of a matching block based on the target motion vector; and
reconstructing the current block based on the pixel values of the matching block.

2. The video decoding method according to claim 1, further comprising:
determining a position of the matching block of the current block based on the target motion vector; and
determining the pixel values of the matching block based on the position of the matching block through second interpolation filtering processing.

3. The video decoding method according to claim 2, wherein the determining the pixel values of the matching block comprises:
determining, based on pixel values in a target reference region in the reference frame, pixel values in a second extension region outside the target reference region; and
determining, based on the pixel values in the second extension region and the target reference region, the pixel values of the matching block through the second interpolation filtering processing.

4. The video decoding method according to claim 3, wherein the target reference region comprises at least one of:
a first pixel position in a search region in the reference frame, or
a second pixel position in the corresponding one of the at least one reference block from which the target motion vector is determined.

5. The video decoding method according to claim 2, wherein
a first quantity of taps of a first interpolation filter in the first interpolation filtering processing and a second quantity of taps of a second interpolation filter in the second interpolation filtering processing are respectively selected from one or more of: 1, 2, 4, 6, 8, or 12.

6. The video decoding method according to claim 5, wherein
the first interpolation filter is a 12-tap interpolation filter, and the second interpolation filter is a 12-tap interpolation filter; or
the first interpolation filter is a 6-tap interpolation filter, and the second interpolation filter is a 12-tap interpolation filter.

7. The video decoding method according to claim 2, wherein
a quantity of taps of the first interpolation filter in a horizontal direction is same as or different from a quantity of taps of the first interpolation filter in a vertical direction; and
a quantity of taps of the second interpolation filter in the horizontal direction is same as or different from a quantity of taps of the second interpolation filter in the vertical direction.

8. The video decoding method according to claim 2, further comprising:
determining a first quantity of taps of a first interpolation filter in the first interpolation filtering processing and a second quantity of taps of a second interpolation filter used in the second interpolation filtering processing based on exchanging information with an encoding entity; or
decoding the bitstream to obtain control information indicating the first quantity of taps of the first interpolation filter in the first interpolation filtering processing and the second quantity of taps of the second interpolation filter used in the second interpolation filtering processing.

9. The video decoding method according to claim 8, wherein the control information comprises one or more of: a flag bit in a sequence header, a flag bit in a picture header, a flag bit in a slice header, a flag bit in a coding tree unit (CTU) header, or a flag bit in a coding block.

10. The video decoding method according to claim 1, wherein
the template prediction region includes a pixel region above the corresponding reference block and a pixel region to a left of the corresponding reference block, and
the first extension region includes at least one of:
a pixel region in a first quantity of rows above the template prediction region;
a pixel region in a second quantity of rows below the template prediction region;
a pixel region in a third quantity of columns to a left side of the template prediction region;
a pixel region in a fourth quantity of columns to a right side of the template prediction region;
a pixel region adjacent to an upper left corner of the template prediction region;
a pixel region adjacent to an upper right corner of the template prediction region;
a pixel region adjacent to a lower left corner of the template prediction region; or
a pixel region adjacent to a lower right corner of the template prediction region.

11. The video decoding method according to claim 1, wherein the determining the pixel values in the respective first extension region comprises at least one of:
copying a pixel value in the template prediction region as a pixel value in the first extension region;
performing replication on a pixel value in the template prediction region based on an axis of symmetry, to obtain a pixel value in the first extension region;
performing replication on a pixel value in the template prediction region based on a symmetry point, to obtain a pixel value in the first extension region;
performing weighted calculation on one or more pixel values in the template prediction region, to obtain a pixel value in the first extension region; or
performing a directional prediction based on one or more pixel values in the template prediction region, to obtain one or more pixel values in the first extension region.

12. A video encoding method, the method comprising:
obtaining video data;
determining, based on the video data, at least one candidate motion vector of a current block;
constructing a template of the current block, the template including pixel points adjacent to the current block;
determining at least one reference block of the current block in a reference frame based on the at least one candidate motion vector;
determining, based on a position of each of the at least one reference block, a respective template prediction region corresponding to each reference block in the reference frame, a position of each template prediction region relative to a corresponding reference block being same as a position of the template relative to the current block;
determining, based on pixel values in the template prediction region corresponding to each reference block, pixel values in a respective first extension region outside the corresponding template prediction region;
determining, based on the pixel values in the first extension region, sub-pixel interpolation values of the template prediction region corresponding to each reference block through first interpolation filtering processing;
searching for a target motion vector through an inter-frame template match process based on the template of the current block and the sub-pixel interpolation values of the template prediction region corresponding to each reference block;
determining pixel values of a matching block based on the target motion vector; and
encoding the current block into a bitstream based on the pixel values of the matching block.

13. The video encoding method according to claim 12, further comprising:
determining a position of the matching block of the current block based on the target motion vector; and
determining the pixel values of the matching block based on the position of the matching block through second interpolation filtering processing.

14. The video encoding method according to claim 13, wherein the determining the pixel values of the matching block comprises:
determining, based on pixel values in a target reference region in the reference frame, pixel values in a second extension region outside the target reference region; and
determining, based on the pixel values in the second extension region and the target reference region, the pixel values of the matching block through the second interpolation filtering processing.

15. The video encoding method according to claim 13, wherein
a first quantity of taps of a first interpolation filter in the first interpolation filtering processing and a second quantity of taps of a second interpolation filter in the second interpolation filtering processing are respectively selected from one or more of: 1, 2, 4, 6, 8, or 12; and
the first quantity of taps of the first interpolation filter is same as or different from the second quantity of taps of the second interpolation filter.

16. The video encoding method according to claim 13, wherein
a quantity of taps of the first interpolation filter in a horizontal direction is same as or different from a quantity of taps of the first interpolation filter in a vertical direction; and
a quantity of taps of the second interpolation filter in the horizontal direction is same as or different from a quantity of taps of the second interpolation filter in the vertical direction.

17. The video encoding method according to claim 12, wherein
the template prediction region includes a pixel region above the corresponding reference block and a pixel region to a left of the corresponding reference block, and
the first extension region includes at least one of:
a pixel region in a first quantity of rows above the template prediction region;
a pixel region in a second quantity of rows below the template prediction region;
a pixel region in a third quantity of columns to a left side of the template prediction region;
a pixel region in a fourth quantity of columns to a right side of the template prediction region;
a pixel region adjacent to an upper left corner of the template prediction region;
a pixel region adjacent to an upper right corner of the template prediction region;
a pixel region adjacent to a lower left corner of the template prediction region; or
a pixel region adjacent to a lower right corner of the template prediction region.

18. The video encoding method according to claim 12, wherein the determining the pixel values in the respective first extension region comprises at least one of:
copying a pixel value in the template prediction region as a pixel value in the first extension region;
performing replication on a pixel value in the template prediction region based on an axis of symmetry, to obtain a pixel value in the first extension region;
performing replication on a pixel value in the template prediction region based on a symmetry point, to obtain a pixel value in the first extension region;
performing weighted calculation on one or more pixel values in the template prediction region, to obtain a pixel value in the first extension region; or
performing a directional prediction based on one or more pixel values in the template prediction region, to obtain one or more pixel values in the first extension region.

19. A non-transitory computer-readable storage medium storing instructions which, when executed by a processor, cause the processor to perform a method of encoding a bitstream, the method comprising:
obtaining video data;
determining, based on the video data, at least one candidate motion vector of a current block;
constructing a template of the current block, the template including pixel points adjacent to the current block;
determining at least one reference block of the current block in a reference frame based on the at least one candidate motion vector;
determining, based on a position of each of the at least one reference block, a respective template prediction region corresponding to each reference block in the reference frame, a position of each template prediction region relative to a corresponding reference block being same as a position of the template relative to the current block;
determining, based on pixel values in the template prediction region corresponding to each reference block, pixel values in a respective first extension region outside the corresponding template prediction region;
determining, based on the pixel values in the first extension region, sub-pixel interpolation values of the template prediction region corresponding to each reference block through first interpolation filtering processing;
searching for a target motion vector through an inter-frame template match process based on the template of the current block and the sub-pixel interpolation values of the template prediction region corresponding to each reference block;
determining pixel values of a matching block based on the target motion vector;
encoding the current block into the bitstream based on the pixel values of the matching block; and
transmitting the encoded bitstream.

20. The non-transitory computer-readable storage medium according to claim 19, wherein the method further comprises:
determining a position of the matching block of the current block based on the target motion vector; and
determining the pixel values of the matching block based on the position of the matching block through second interpolation filtering processing.
